(19) United States
(12) Patent Application Publication
(10) Pub. No.: US 2026/0177786 A1
(43) Pub. Date: Jun. 25, 2026

(54) OPTICAL IMAGING SYSTEM

(71) Applicant: Samsung Electro-Mechanics Co., Ltd., Suwon-si (KR)

(72) Inventor: Sang Hyun JANG, Suwon-si (KR)

(73) Assignee: Samsung Electro-Mechanics Co., Ltd., Suwon-si (KR)

(21) Appl. No.: 19/407,183

(22) Filed: Dec. 3, 2025

(30) Foreign Application Priority Data
Dec. 23, 2024 (KR) 10-2024-0194346

(51) Int. Cl. G02B 13/00; G02B 9/64

(52) U.S. Cl. CPC G02B 13/0045; G02B 9/64

(57) ABSTRACT

An optical imaging system includes a first lens, a second lens, a third lens, a fourth lens, a fifth lens, a sixth lens, a seventh lens, and an eighth lens sequentially disposed along an optical axis toward an imaging plane, wherein the first lens has a positive refractive power, the second lens has a negative refractive power, and the third lens has a positive refractive power, and 0.95<(TTL/(2ΔIMG HT))×Fno<1.00 and 6.9<TTL/BFL<8.5 are satisfied, where TTL is a distance along the optical axis from an object-side surface of the first lens to the imaging plane, IMG HT is one half of a diagonal length of the imaging plane, Fno is an F-number of the optical imaging system, and BFL is a distance along the optical axis from an image-side surface of the eighth lens to the imaging plane.

### CROSS-REFERENCE TO RELATED APPLICATIONS

This application claims the benefit under 35 USC 119(a) of Korean Patent Application No. 10-2024-0194346 filed on Dec. 23, 2024, in the Korean Intellectual Property Office, the entire disclosure of which is incorporated herein by reference for all purposes.

### BACKGROUND

### 1. Field

The present disclosure relates to an optical imaging system.

### 2. Description of Background

A recent portable terminal may include a camera including an optical imaging system including a plurality of lenses to enable video calls and image capturing.

In addition, as functions of cameras in portable terminals gradually increase, a demand for cameras for portable terminals having a high resolution has been increasing.

In particular, in recent years, image sensors having a high number of pixels (for example, 13 million to 100 million pixels) have been adopted in cameras for portable terminals in order to implement a higher image quality.

That is, an image sensor has increased in size, and accordingly, a total track length (TTL) of an optical imaging system has also increased, which eventually causes an issue in that a camera protrudes from a portable terminal.

In addition, as portable terminals gradually decrease in size, a reduction in thickness has been needed for cameras for portable terminals. Thus, it is necessary to develop an optical imaging system having a reduced thickness and a high resolution.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens, a second lens, a third lens, a fourth lens, a fifth lens, a sixth lens, a seventh lens, and an eighth lens sequentially disposed in ascending numerical order along an optical axis of the optical imaging system from an object side of the optical imaging system toward an imaging plane of the optical imaging system, wherein the first lens has a positive refractive power, the second lens has a negative refractive power, and the third lens has a positive refractive power, and the conditional expressions 0.95<(TTL/(2×IMG HT))×Fno<1.00 and 6.9<TTL/BFL<8.5 are satisfied, where TTL is a distance along the optical axis from an object-side surface of the first lens to the imaging plane, IMG HT is one half of a diagonal length of the imaging plane, Fno is an F-number of the optical imaging system, and BFL is a distance along the optical axis from an image-side surface of the eighth lens to the imaging plane.

A refractive index of the second lens may be greater than a refractive index of the first lens and a refractive index of the third lens, and a refractive index of the fourth lens may be greater than the refractive index of the third lens and a refractive index of the fifth lens.

The second lens and the fourth lens each may have a refractive index greater than 1.67.

The fourth lens may have a negative refractive power, and the second lens and the fourth lens each may have an Abbe number less than 20.

Either one or both of the conditional expressions 30<v2+v4<40 and 15<v1−(v2+v4)<20 may be satisfied, where v1 is an Abbe number of the first lens, v2 is an Abbe number of the second lens, and v4 is an Abbe number of the fourth lens.

The conditional expression 1.5<Fno<1.58 may be satisfied.

The conditional expression 0.6<TTL/(2×IMG HT)<0.64 may be satisfied.

The conditional expression 0<d45/TTL<0.03 may be satisfied, where d45 is a distance along the optical axis between an image-side surface of the fourth lens and an object-side surface of the fifth lens.

The conditional expression 1.1<TTL/f<1.25 may be satisfied, where f is a total focal length of the optical imaging system.

The conditional expression 0.15<R1/R2<0.35 may be satisfied, where R1 is a radius of curvature of the object-side surface of the first lens at the optical axis, and R2 is a radius of curvature of an image-side surface of the first lens at the optical axis.

The conditional expression 0.12<(R1/R2)/T1<0.3 may be satisfied, where R1 is a radius of curvature of the object-side surface of the first lens at the optical axis, R2 is a radius of curvature of an image-side surface of the first lens at the optical axis, and T1 is a thickness of the first lens along the optical axis.

The conditional expression 0.85<f1/f<1.05 may be satisfied, where f1 is a focal length of the first lens, and f is a total focal length of the optical imaging system.

The conditional expression −3<f2/f<−1.8 may be satisfied, where f2 is a focal length of the second lens, and f is a total focal length of the optical imaging system.

The conditional expression 0.3<|f1/f2|<0.5 may be satisfied, where f1 is a focal length of the first lens, and f2 is a focal length of the second lens.

The seventh lens may have a positive refractive power, and the eighth lens may have a negative refractive power.

The object-side surface of the first lens may be convex in a paraxial region thereof, and an image-side surface of the first lens may be concave in a paraxial region thereof, an object-side surface of the second lens may be convex in a paraxial region thereof, and an image-side surface of the second lens may be concave in a paraxial region thereof, and an object-side surface of the third lens may be convex in a paraxial region thereof, and an image-side surface of the third lens may be concave in a paraxial region thereof.

The conditional expression 5<f3/f<10 may be satisfied, where f3 is a focal length of the third lens, and f is a total focal length of the optical imaging system.

The conditional expression −10<f4/f<−4 may be satisfied, where f4 is a focal length of the fourth lens, and f is a total focal length of the optical imaging system.

The conditional expression 0.07<|f1/f3|<0.2 may be satisfied, where f1 is a focal length of the first lens, and f3 is a focal length of the third lens.

The conditional expression 0.2<|f2/f3|<0.5 may be satisfied, where f2 is a focal length of the second lens, and f3 is a focal length of the third lens.

Other features and aspects will be apparent from the following detailed description, the drawings, and the claims.

### BRIEF DESCRIPTION OF DRAWINGS

FIG. 1 is a block diagram illustrating an optical imaging system according to a first embodiment of the present disclosure.

FIG. 2 is a diagram illustrating aberration properties of the optical imaging system illustrated in FIG. 1.

FIG. 3 is a block diagram illustrating an optical imaging system according to a second embodiment of the present disclosure.

FIG. 4 is a diagram illustrating aberration properties of the optical imaging system illustrated in FIG. 3.

FIG. 5 is a block diagram illustrating an optical imaging system according to a third embodiment of the present disclosure.

FIG. 6 is a diagram illustrating aberration properties of the optical imaging system illustrated in FIG. 5.

FIG. 7 is a block diagram illustrating an optical imaging system according to a fourth embodiment of the present disclosure.

FIG. 8 is a diagram illustrating aberration properties of the optical imaging system illustrated in FIG. 7.

FIG. 9 is a block diagram illustrating an optical imaging system according to a fifth embodiment of the present disclosure.

FIG. 10 is a diagram illustrating aberration properties of the optical imaging system illustrated in FIG. 9.

FIG. 11 is a block diagram illustrating an optical imaging system according to a sixth embodiment of the present disclosure.

FIG. 12 is a diagram illustrating aberration properties of the optical imaging system illustrated in FIG. 11.

FIG. 13 is a block diagram illustrating an optical imaging system according to a seventh embodiment of the present disclosure.

FIG. 14 is a diagram illustrating aberration properties of the optical imaging system illustrated in FIG. 13.

FIG. 15 is a block diagram illustrating an optical imaging system according to an eighth embodiment of the present disclosure.

FIG. 16 is a diagram illustrating aberration properties of the optical imaging system illustrated in FIG. 15.

FIG. 17 is a block diagram illustrating an optical imaging system according to a ninth embodiment of the present disclosure.

FIG. 18 is a diagram illustrating aberration properties of the optical imaging system illustrated in FIG. 17.

FIG. 19 is a block diagram illustrating an optical imaging system according to a tenth embodiment of the present disclosure.

FIG. 20 is a diagram illustrating aberration properties of the optical imaging system illustrated in FIG. 19.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the drawings, the thicknesses, sizes, and shapes of the lenses may be exaggerated for clarity of illustration. In particular, aspherical shapes of the lens surfaces illustrated in the drawings are only presented as examples, but are not limited thereto.

An optical imaging system according to an embodiment of the present disclosure may be mounted in a portable electronic device. For example, the optical imaging system may be a component of a camera module mounted in the portable electronic device. The portable electronic device may be a portable electronic device such as a mobile communication terminal, a smartphone, a tablet PC, or any other portable electronic device.

In addition, as used herein, numerical values of a radius of curvature, a thickness, a distance, a focal length, and other dimensions are expressed in millimeters (mm), and a field of view (FOV) is expressed in degrees (°).

In addition, in a description of a shape of a lens, a statement that a surface of a lens has a convex shape means that a paraxial region of the surface has a convex shape, and a statement that a surface of a lens has a concave shape means that a paraxial region of the surface has a concave shape. Accordingly, even when it is stated that a surface of a lens has a convex shape, an edge portion of the surface of the lens may have a concave shape. Similarly, even when it is stated that a surface of a lens has a concave shape, an edge portion of the surface of the lens may have a convex shape.

A paraxial region of a lens surface is a very narrow region around an optical axis of the lens surface.

In greater detail, a paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid.

The imaging plane may be a virtual surface on which a focal point is formed by the optical imaging system. Alternatively, the imaging plane be a surface of an image sensor receiving light through the optical imaging system.

The optical imaging system according to an embodiment of the present disclosure may include a plurality of lenses. For example, the optical imaging system may include eight lenses.

In an embodiment, the optical imaging system may include a first lens, a second lens, a third lens, a fourth lens, a fifth lens, a sixth lens, a seventh lens, and an eighth lens sequentially disposed in ascending numerical order along an optical axis of the optical imaging system from an object side of the optical imaging system toward an imaging plane of the optical imaging system. The first to eighth lenses may be spaced apart from each other by predetermined distances along the optical axis.

The first lens may refer to a lens disposed closest to the object side of the optical imaging system, and the eighth lens may refer to a lens disposed closest to the imaging plane (or the image sensor).

The optical imaging system according to an embodiment of the present disclosure may further include an image sensor for converting an image of an incident subject into an electrical signal.

In addition, the optical imaging system may further include an infrared filter (hereinafter, referred to as a filter) for blocking infrared rays. The filter may be disposed between the eighth lens and the image sensor.

In addition, the optical imaging system may further include a stop for adjusting an amount of light passing through the optical imaging system. The stop may be disposed between the third lens and the fourth lens.

Each of the first to eighth lenses included in the optical imaging system according to an embodiment of the present disclosure may be made of a plastic material.

In addition, any one or any combination of any two or more of the first to eighth lenses may have an aspherical surface. For example, each of the first to eighth lenses may have at least one aspherical surface.

That is, either one or both of an object-side surface and an image-side surface of each of the first to eighth lenses may be an aspherical surface. The aspherical surfaces of each of the first to the eighth lenses is defined by Equation 1 below.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} … \qquad ( 1 )$$

In Equation 1, c is a curvature of the lens surface and is equal to a reciprocal of a radius of curvature of the lens surface at an optical axis of the lens surface, K is a conic constant, and Y is a distance from any point on the aspherical surface of the lens to the optical axis. In addition, constants A to H, J, and L to P are aspherical surface coefficients. Z (also known as sag) is a distance in a direction parallel to an optical axis direction between the point on the aspherical surface of the lens at the distance Y from the optical axis of the aspherical surface to a tangential plane perpendicular to the optical axis and intersecting a vertex of the aspherical surface.

The optical imaging system according to an embodiment of the present disclosure may satisfy any one or any combination of any two or more of the following Conditional Expressions 1 to 17.

$$0.6 < TTL / ( 2 \times IMG HT ) < 0.64 \qquad ( Conditional Expression 1 )$$

$$1.5 < Fno < 1.58 \qquad ( Conditional Expression 2 )$$

$$0.95 < ( TTL / ( 2 \times IMG HT ) ) \times Fno < 1. \qquad ( Conditional Expression 3 )$$

$$0 < d 45 / TTL < 0.03 \qquad ( Conditional Expression 4 )$$

$$1.1 < TTL / f < 1.25 \qquad ( Conditional Expression 5 )$$

$$6.9 < TTL / BFL < 8.5 \qquad ( Conditional Expression 6 )$$

$$30 < v 2 + v 4 < 40 \qquad ( Conditional Expression 7 )$$

$$15 < v 1 - ( v 2 + v 4 ) < 20 \qquad ( Conditional Expression 8 )$$

$$0.15 < R 1 / R 2 < 0.35 \qquad ( Conditional Expression 9 )$$

$$0.12 < ( R 1 / R 2 ) / T 1 < 0.3 \qquad ( Conditional Expression 10 )$$

$$0.85 < f 1 / f < 1.05 \qquad ( Conditional Expression 11 )$$

$$- 3 < f 2 / f < - 1.8 \qquad ( Conditional Expression 12 )$$

$$5 < f 3 / f < 10 \qquad ( Conditional Expression 13 )$$

$$- 10 < f 4 / f < - 4 \qquad ( Conditional Expression 14 )$$

$$0.3 < \vert f 1 / f 2 \vert < 0.5 \qquad ( Conditional Expression 15 )$$

$$0.07 < \vert f 1 / f 3 \vert < 0.2 \qquad ( Conditional Expression 16 )$$

$$0.2 < \vert f 2 / f 3 \vert < 0.5 \qquad ( Conditional Expression 17 )$$

In an embodiment, the optical imaging system may satisfy 0.60<TTL/(2×IMG HT)<0.64 (Conditional Expression 1). Here, TTL is a distance along the optical axis from an object-side surface of the first lens to the imaging plane, and IMG HT is one half of a diagonal length of the imaging plane. Accordingly, the optical imaging system may be reduced in size.

In an embodiment, the optical imaging system may satisfy 1.5<Fno<1.58 (Conditional Expression 2). Here, Fno is an F-number of the optical imaging system. Accordingly, an image brightness and a resolution may be improved.

In an embodiment, the optical imaging system may satisfy 0.95<(TTL/(2×IMG HT))×Fno<1.00 (Conditional Expression 3). Accordingly, the optical imaging system may be reduced in size while image brightness is improved.

In an embodiment, the optical imaging system may satisfy 0<d45/TTL<0.03 (Conditional Expression 4). In this case, a difference between an Abbe number of the fourth lens and an Abbe number of the fifth lens may be greater than 35 and less than 40. Here, d45 is a distance along the optical axis between an image-side surface of the fourth lens and an object-side surface of the fifth lens. Accordingly, chromatic aberration may be improved, and a resolution may be improved.

In an embodiment, the optical imaging system may satisfy 1.1<TTL/f<1.25 (Conditional Expression 5). Here, f is a total focal length of the optical imaging system. Accordingly, the optical imaging system may be reduced in size while an appropriate field of view is implemented.

In an embodiment, the optical imaging system may satisfy 6.9<TTL/BFL<8.5 (Conditional Expression 6). Here, BFL is a distance along the optical axis from an image-side surface of the eighth lens to the imaging plane. Accordingly, a distance between the eighth lens and the image sensor may be appropriately adjusted to improve an assembly reliability of the optical imaging system.

In an embodiment, the optical imaging system may satisfy 30<v2+v4<40 (Conditional Expression 7). Here, v2 is an Abbe number of the second lens, and v4 is an Abbe number of the fourth lens. Accordingly, a resolution may be improved.

In an embodiment, the optical imaging system may satisfy 15<v1−(v2+v4)<20 (Conditional Expression 8). Here, v1 is an Abbe number of the first lens. Accordingly, a resolution may be improved.

In an embodiment, the optical imaging system may satisfy 0.15<R1/R2<0.35 (Conditional Expression 9). Here, R1 is a radius of curvature of an object-side surface of the first lens at the optical axis, and R2 is a radius of curvature of an image-side surface of the first lens at the optical axis. Accordingly, a refractive power of the first lens may be appropriately adjusted to improve a resolution.

In an embodiment, the optical imaging system may satisfy 0.12<(R1/R2)/T1<0.3 (Conditional Expression 10). Here, T1 is a thickness of the first lens along the optical axis. Accordingly, a refractive power of the first lens may be appropriately adjusted to improve a resolution.

In an embodiment, the optical imaging system may satisfy 0.85<f1/f<1.05 (Conditional Expression 11). Here, f1 is a focal length of the first lens. Accordingly, a refractive power of the first lens may be appropriately adjusted to improve a resolution.

In an embodiment, the optical imaging system may satisfy −3<f2/f<−1.8 (Conditional Expression 12). Here, f2 is a focal length of the second lens. Accordingly, a refractive power of the second lens may be appropriately adjusted to improve a resolution.

In an embodiment, the optical imaging system may satisfy 5<f3/f<10 (Conditional Expression 13). Here, f3 is a focal length of the third lens. Accordingly, a refractive power of the third lens may be appropriately adjusted to improve a resolution.

In an embodiment, the optical imaging system may satisfy −10<f4/f<−4 (Conditional Expression 14). Here, f4 is a focal length of the fourth lens. Accordingly, a refractive power of the fourth lens may be appropriately adjusted to improve a resolution.

In an embodiment, the optical imaging system may satisfy 0.3<|f1/f2|<0.5 (Conditional Expression 15). Accordingly, a refractive power of the first lens and the second lens may be appropriately adjusted to improve a resolution.

In an embodiment, the optical imaging system may satisfy 0.07<|f1/f3|<0.2 (Conditional Expression 16). Accordingly, a refractive power of the first lens and the third lens may be appropriately adjusted to improve a resolution.

In an embodiment, the optical imaging system may satisfy 0.2<|f2/f3|<0.5 (Conditional Expression 17). Accordingly, a refractive power of the second lens and the third lens may be appropriately adjusted to improve a resolution.

Two or more lenses among the first to eighth lenses may be lenses having a relatively high refractive index.

In an embodiment, the second lens and the fourth lens may have refractive indices higher than refractive indices of lenses adjacent thereto. For example, a refractive index of the second lens may be higher than a refractive index of the first lens and a refractive index of the third lens. A refractive index of the fourth lens may be higher than a refractive index of the third lens and a refractive index of the fifth lens.

In an embodiment, the second lens and the fourth lens may each have a refractive index greater than 1.67.

Two or more lenses among the first to eighth lenses may have an Abbe number less than 20. For example, each of the second lens and the fourth lens may have an Abbe number less than 20.

Each of the lenses having an Abbe number less than 20 may have a negative refractive power.

In an embodiment, a number of the lenses having an Abbe number less than 20 may be two.

Either one or both of an object-side surface and an image-side surface of any one lens or any combination of any two or more lenses among the sixth to eighth lenses may have at least one inflection point. For example, a paraxial region of an object-side surface of the seventh lens may have a convex shape, and a portion of the object-side surface of the seventh lens, other than the paraxial region, may have a concave shape.

A field of view of the optical imaging system according to an embodiment of the present disclosure may be greater than 80° and less than 90°.

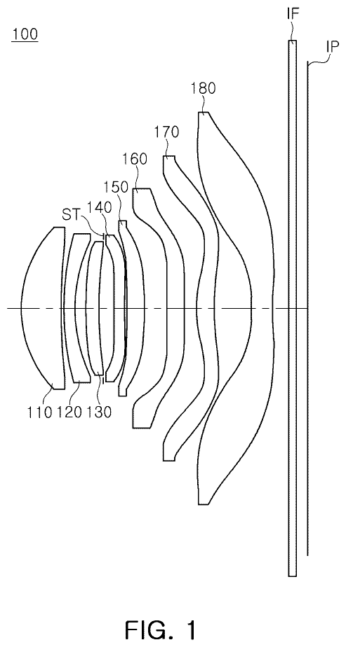

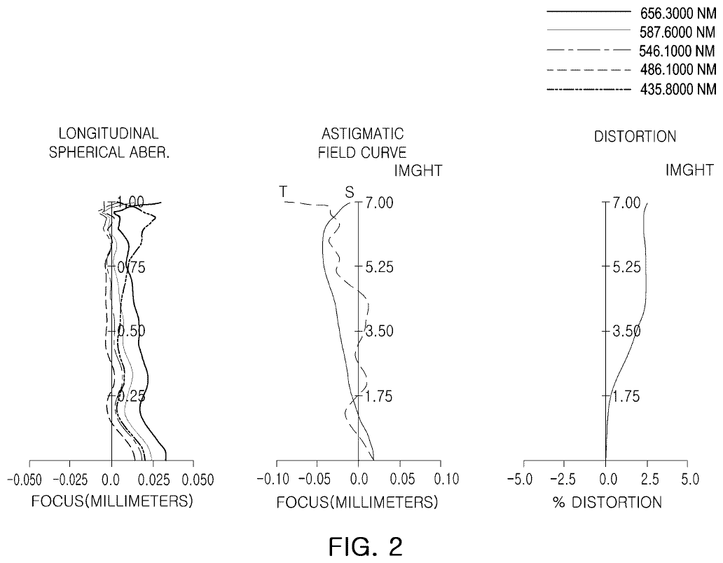

FIG. 1 is a block diagram illustrating an optical imaging system according to a first embodiment of the present disclosure, and FIG. 2 is a diagram illustrating aberration properties of the optical imaging system illustrated in FIG. 1.

Referring to FIG. 1, an optical imaging system 100 according to a first embodiment of the present disclosure may include a first lens 110, a second lens 120, a third lens 130, a fourth lens 140, a fifth lens 150, a sixth lens 160, a seventh lens 170, and an eighth lens 180 sequentially disposed in ascending numerical order along an optical axis of the optical imaging system 100 from an object side of the optical imaging system 100 toward an imaging plane P of the optical imaging system 100, and may further include a filter F and an image sensor (not shown) that which may include the imaging plane IP.

The optical imaging system 100 may further include a stop ST. The stop ST may be disposed between the third lens 130 and the fourth lens 140. For example, the stop ST may be disposed closer to an image-side surface of the third lens 130 than to an object-side surface of the fourth lens 140.

The optical imaging system 100 according to the first embodiment of the present disclosure may form a focal point on the imaging plane IP.

Lens properties (a radius of curvature, a thickness of a lens or a distance between lenses, a refractive index, an Abbe number, and an effective radius) of each lens are listed in Table 1 below.

TABLE 1

| Surface | | Radius of | Thickness/ | Refractive | Abbe | Effective |
|---|---|---|---|---|---|---|
| No. | Element | Curvature | Distance | Index | Number | Radius |
| S1 | First | 3.047 | 1.243 | 1.546 | 55.990 | 2.360 |
| S2 | Lens | 14.857 | 0.083 | | | 2.282 |
| S3 | Second | 10.046 | 0.310 | 1.695 | 18.408 | 2.171 |
| S4 | Lens | 5.260 | 0.343 | | | 1.988 |
| S5 | Third | 9.067 | 0.390 | 1.546 | 55.990 | 1.951 |
| S6 | Lens | 11.845 | 0.171 | | | 1.872 |
| S7 | Stop | Infinity | 0.306 | | | 1.909 |
| S8 | Fourth | 28.921 | 0.310 | 1.695 | 18.408 | 1.910 |
| S9 | Lens | 13.595 | 0.091 | | | 2.220 |
| S10 | Fifth | 29.940 | 0.517 | 1.546 | 55.990 | 2.451 |
| S11 | Lens | −34.928 | 0.671 | | | 2.587 |
| S12 | Sixth | 20.215 | 0.530 | 1.571 | 37.403 | 2.897 |
| S13 | Lens | 14.361 | 0.381 | | | 3.484 |
| S14 | Seventh | 2.916 | 0.530 | 1.555 | 45.248 | 4.217 |
| S15 | Lens | 6.596 | 1.158 | | | 4.444 |
| S16 | Eighth | −5.705 | 0.610 | 1.537 | 55.730 | 5.546 |
| S17 | Lens | 5.481 | 0.534 | | | 5.739 |
| S18 | Filter | Infinity | 0.210 | 1.518 | 64.197 | |
| S19 | | Infinity | 0.282 | | | |
| S20 | Imaging | Infinity | | | | |
| | Plane | | | | | |

In the first embodiment of the present disclosure, the first lens 110 may have a positive refractive power. An object-side surface of the first lens 110 may have a convex shape in a paraxial region thereof, and an image-side surface of the first lens 110 may have a concave shape in a paraxial region thereof.

The second lens 120 may have a negative refractive power. An object-side surface of the second lens 120 may have a convex shape in a paraxial region thereof, and an image-side surface of the second lens 120 may have a concave shape in a paraxial region thereof.

The third lens 130 may have a positive refractive power. An object-side surface of the third lens 130 may have a convex shape in a paraxial region thereof, and an image-side surface of the third lens 130 may have a concave shape in a paraxial region thereof.

The fourth lens 140 may have a negative refractive power. An object-side surface of the fourth lens 140 may have a convex shape in a paraxial region thereof, and an image-side surface of the fourth lens 140 may have a concave shape in a paraxial region thereof.

The fifth lens 150 may have a positive refractive power. Both an object-side surface and an image-side surface of the fifth lens 150 may have a convex shape in respective paraxial regions thereof.

The sixth lens 160 may have a negative refractive power. An object-side surface of the sixth lens 160 may have a convex shape in a paraxial region thereof, and an image-side surface of the sixth lens 160 may have a concave shape in a paraxial region thereof.

In addition, either one or both of the object-side surface and the image-side surface of the sixth lens 160 may have at least one inflection point. For example, a paraxial region of the object-side surface of the sixth lens 160 may have a convex shape, and a portion of the object-side surface of the sixth lens 160, other than the paraxial region, may have a concave shape. In addition, a paraxial region of the image-side surface of the sixth lens 160 may have a concave shape, and a portion of the image-side surface of the sixth lens 160, other than the paraxial region, may have a convex shape.

The seventh lens 170 may have a positive refractive power. An object-side surface of the seventh lens 170 may have a convex shape in a paraxial region thereof, and an image-side surface of the seventh lens 170 may have a concave shape in a paraxial region thereof.

In addition, either one or both of the object-side surface and the image-side surface of the seventh lens 170 may have at least one inflection point. For example, a paraxial region of the object-side surface of the seventh lens 170 may have a convex shape, and a portion of the object-side surface of the seventh lens 170, other than the paraxial region, may have a concave shape. In addition, a paraxial region of the image-side surface of the seventh lens 170 may have a concave shape, and a portion of the image-side surface of the seventh lens 170, other than the paraxial region, may have a convex shape.

The eighth lens 180 may have a negative refractive power. Both an object-side surface and an image-side surface of the eighth lens 180 may have a concave shape in respective paraxial regions thereof.

In addition, either one or both of the object-side surface and the image-side surface of the eighth lens 180 may have at least one inflection point. For example, a paraxial region of the object-side surface of the eighth lens 180 may have a concave shape, and a portion of the object-side surface of the eighth lens 180, other than the paraxial region, may have a convex shape. In addition, a paraxial region of the image-side surface of the eighth lens 180 may have a concave shape, and a portion of the image-side surface of the eighth lens 180, other than the paraxial region, may have a convex shape.

Each surface of each of the first to eighth lenses 110 to 180 may have a conic constant K and aspherical surface coefficients A to H, J, and L to P according to Equation 1 discussed above as listed in Table 2 below. Accordingly, the object-side surfaces and the image-side surfaces of the first lens 110 to the eighth lens 180 may all be aspherical surfaces.

TABLE 2

| | S1 | S2 | S3 | S4 | S5 | S6 |
|---|---|---|---|---|---|---|
| K | −1.206E+00 | 6.316E−01 | 3.579E+00 | −2.679E−01 | −5.102E+00 | −1.346E+00 |
| A | 4.537E−03 | −8.037E−04 | −4.324E−03 | −2.540E−03 | −7.707E−04 | −4.427E−03 |
| B | 2.491E−03 | −1.004E−02 | −1.109E−03 | 4.696E−03 | −2.848E−02 | −4.970E−03 |
| C | −8.080E−03 | 2.828E−02 | 1.122E−02 | −3.558E−03 | 1.001E−01 | 2.353E−02 |
| D | 1.646E−02 | −4.719E−02 | −2.156E−02 | −9.890E−04 | −2.163E−01 | −7.207E−02 |
| E | −2.049E−02 | 5.298E−02 | 2.653E−02 | 1.126E−02 | 3.100E−01 | 1.426E−01 |
| F | 1.673E−02 | −4.162E−02 | −2.250E−02 | −2.017E−02 | −3.083E−01 | −1.923E−01 |
| G | −9.395E−03 | 2.335E−02 | 1.345E−02 | 2.036E−02 | 2.189E−01 | 1.823E−01 |
| H | 3.721E−03 | −9.460E−03 | −5.737E−03 | −1.340E−02 | −1.126E−01 | −1.234E−01 |
| J | −1.050E−03 | 2.769E−03 | 1.747E−03 | 6.023E−03 | 4.205E−02 | 5.983E−02 |
| L | 2.099E−04 | −5.800E−04 | −3.759E−04 | −1.870E−03 | −1.130E−02 | −2.059E−02 |
| M | −2.905E−05 | 8.470E−05 | 5.570E−05 | 3.949E−04 | 2.129E−03 | 4.908E−03 |
| N | 2.647E−06 | −8.188E−06 | −5.387E−06 | −5.417E−05 | −2.670E−04 | −7.697E−04 |
| O | −1.429E−07 | 4.706E−07 | 3.050E−07 | 4.353E−06 | 2.002E−05 | 7.141E−05 |
| P | 3.457E−09 | −1.218E−08 | −7.632E−09 | −1.554E−07 | −6.789E−07 | −2.967E−06 |
| | S8 | S9 | S10 | S11 | S12 | S13 |
| K | 9.000E+01 | −1.944E+01 | −7.719E+01 | 9.000E+01 | −6.477E+01 | −8.999E+01 |
| A | −1.150E−02 | −1.973E−02 | −2.274E−02 | −1.660E−02 | −1.693E−02 | −5.524E−02 |
| B | −9.194E−03 | 6.852E−04 | −2.294E−02 | −1.740E−02 | 4.876E−03 | 3.097E−02 |
| C | 1.899E−02 | 1.884E−02 | 8.091E−02 | 4.991E−02 | 3.181E−03 | −1.560E−02 |
| D | −2.628E−02 | −5.760E−02 | −1.466E−01 | −8.303E−02 | −8.958E−03 | 6.570E−03 |
| E | 8.779E−03 | 8.973E−02 | 1.694E−01 | 8.876E−02 | 8.562E−03 | −2.581E−03 |
| F | 2.723E−02 | −8.946E−02 | −1.304E−01 | −6.431E−02 | −5.258E−03 | 8.837E−04 |
| G | −5.178E−02 | 6.122E−02 | 6.864E−02 | 3.267E−02 | 2.276E−03 | −2.387E−04 |
| H | 4.771E−02 | −2.990E−02 | −2.504E−02 | −1.184E−02 | −7.084E−04 | 4.787E−05 |
| J | −2.763E−02 | 1.061E−02 | 6.362E−03 | 3.076E−03 | 1.582E−04 | −6.893E−06 |
| L | 1.066E−02 | −2.730E−03 | −1.119E−03 | −5.674E−04 | −2.497E−05 | 6.962E−07 |
| M | −2.750E−03 | 4.955E−04 | 1.331E−04 | 7.244E−05 | 2.704E−06 | −4.793E−08 |
| N | 4.563E−04 | −6.001E−05 | −1.018E−05 | −6.077E−06 | −1.904E−07 | 2.139E−09 |
| O | −4.413E−05 | 4.336E−06 | 4.486E−07 | 3.008E−07 | 7.826E−09 | −5.573E−11 |
| P | 1.892E−06 | −1.409E−07 | −8.599E−09 | −6.646E−09 | −1.422E−10 | 6.435E−13 |

| | S14 | S15 | S16 | S17 |
|---|---|---|---|---|
| K | −9.434E−01 | −1.294E+00 | −2.661E+01 | −1.056E+00 |
| A | −4.563E−02 | −3.579E−03 | −7.144E−02 | −5.628E−02 |
| B | 1.159E−02 | −6.503E−03 | 2.577E−02 | 1.918E−02 |
| C | −2.880E−03 | 4.144E−03 | −6.730E−03 | −4.988E−03 |
| D | 3.040E−04 | −1.738E−03 | 1.243E−03 | 9.611E−04 |
| E | 3.590E−05 | 4.774E−04 | −1.544E−04 | −1.376E−04 |
| F | −2.195E−05 | −9.072E−05 | 1.286E−05 | 1.470E−05 |
| G | 4.687E−06 | 1.231E−05 | −7.113E−07 | −1.171E−06 |
| H | −5.982E−07 | −1.201E−06 | 2.456E−08 | 6.929E−08 |
| J | 4.976E−08 | 8.368E−08 | −3.895E−10 | −3.016E−09 |
| L | −2.763E−09 | −4.092E−09 | −6.461E−12 | 9.491E−11 |
| M | 1.016E−10 | 1.360E−10 | 5.072E−13 | −2.095E−12 |
| N | −2.381E−12 | −2.899E−12 | −1.226E−14 | 3.072E−14 |
| O | 3.219E−14 | 3.529E−14 | 1.462E−16 | −2.684E−16 |
| P | −1.915E−16 | −1.829E−16 | −7.224E−19 | 1.057E−18 |

In addition, the optical imaging system configured as described above may have aberration properties as illustrated in FIG. 2.

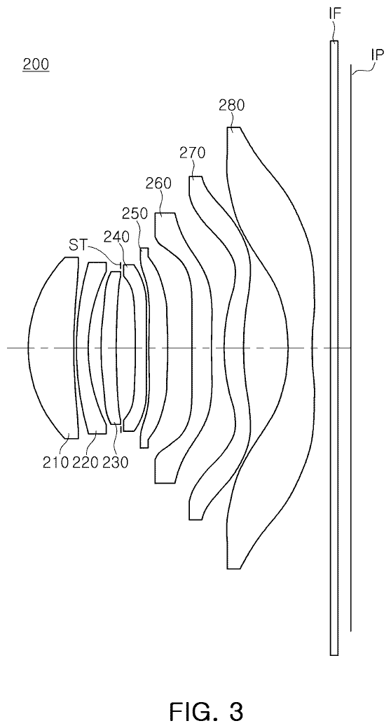

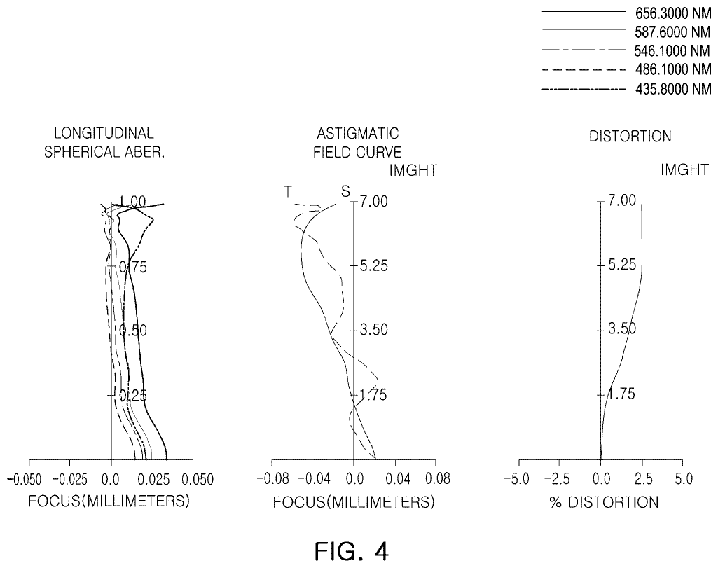

FIG. 3 is a block diagram illustrating an optical imaging system according to a second embodiment of the present disclosure, and FIG. 4 is a diagram illustrating aberration properties of the optical imaging system illustrated in FIG. 3.

Referring to FIG. 3, an optical imaging system 200 according to the second embodiment of the present disclosure may include a first lens 210, a second lens 220, a third lens 230, a fourth lens 240, a fifth lens 250, a sixth lens 260, a seventh lens 270, and an eighth lens 280 sequentially disposed in ascending numerical order along an optical axis of the optical imaging system 200 from an object side of the optical imaging system 200 toward an imaging plane IP of the optical imaging system 200, and may further include a filter F and an image sensor (not shown) that may include the imaging plane IP.

The optical imaging system 200 may further include a stop ST. The stop ST may be disposed between the third lens 230 and the fourth lens 240. For example, the stop ST may be disposed closer to an image-side surface of the third lens 230 than to an object-side surface of the fourth lens 240.

The optical imaging system 200 according to the second embodiment of the present disclosure may form a focal point on the imaging plane IP.

Lens properties (a radius of curvature, a thickness of a lens or a distance between lenses, a refractive index, an Abbe number, and an effective radius) of each lens are listed in Table 3 below.

TABLE 3

| Surface | | Radius of | Thickness/ | Refractive | Abbe | Effective |
|---|---|---|---|---|---|---|
| No. | Element | Curvature | Distance | Index | Number | Radius |
| S1 | First | 3.052 | 1.239 | 1.546 | 55.990 | 2.364 |
| S2 | Lens | 16.279 | 0.073 | | | 2.299 |
| S3 | Second | 10.087 | 0.310 | 1.695 | 18.408 | 2.197 |
| S4 | Lens | 5.045 | 0.340 | | | 2.011 |
| S5 | Third | 8.086 | 0.390 | 1.546 | 55.990 | 1.970 |
| S6 | Lens | 11.424 | 0.181 | | | 1.853 |
| S7 | Stop | Infinity | 0.344 | | | 1.836 |
| S8 | Fourth | −43.717 | 0.310 | 1.695 | 18.408 | 1.882 |
| S9 | Lens | Infinity | 0.050 | | | 2.163 |
| S10 | Fifth | 30.378 | 0.500 | 1.546 | 55.990 | 2.427 |
| S11 | Lens | 291.442 | 0.647 | | | 2.594 |
| S12 | Sixth | 19.326 | 0.530 | 1.571 | 37.403 | 2.912 |
| S13 | Lens | 10.673 | 0.330 | | | 3.493 |
| S14 | Seventh | 2.808 | 0.530 | 1.555 | 45.248 | 4.199 |
| S15 | Lens | 7.278 | 1.215 | | | 4.419 |
| S16 | Eighth | −7.121 | 0.610 | 1.537 | 55.730 | 5.474 |
| S17 | Lens | 4.801 | 0.534 | | | 5.673 |
| S18 | Filter | Infinity | 0.210 | 1.518 | 64.197 | |
| S19 | | Infinity | 0.327 | | | |
| S20 | Imaging | Infinity | | | | |
| | Plane | | | | | |

In the second embodiment of the present disclosure, the first lens 210 may have a positive refractive power. An object-side surface of the first lens 210 may have a convex shape in a paraxial region thereof, and an image-side surface of the first lens 210 may have a concave shape in a paraxial region thereof.

The second lens 220 may have a negative refractive power. An object-side surface of the second lens 220 may have a convex shape in a paraxial region thereof, and an image-side surface of the second lens 220 may have a concave shape in a paraxial region thereof.

The third lens 230 may have a positive refractive power. An object-side surface of the third lens 230 may have a convex shape in a paraxial region thereof, and an image-side surface of the third lens 230 may have a concave shape in a paraxial region thereof.

The fourth lens 240 may have a negative refractive power. An object-side surface of the fourth lens 240 may have a concave shape in a paraxial region thereof, and an image-side surface of the fourth lens 240 may have a flat shape in at least a paraxial region thereof.

The fifth lens 250 may have a positive refractive power. An object-side surface of the fifth lens 250 may have a convex shape in a paraxial region thereof, and an image-side surface of the fifth lens 250 may have a concave shape in a paraxial region thereof.

The sixth lens 260 may have a negative refractive power. An object-side surface of the sixth lens 260 may have a convex shape in a paraxial region thereof, and an image-side surface of the sixth lens 260 may have a concave shape in a paraxial region thereof.

In addition, either one or both of the object-side surface and the image-side surface of the sixth lens 260 may have at least one inflection point. For example, a paraxial region of the object-side surface of the sixth lens 260 may have a convex shape, and a portion of the object-side surface of the sixth lens 260, other than the paraxial region, may have a concave shape. In addition, a paraxial region of the image-side surface of the sixth lens 260 may have a concave shape, and a portion of the image-side surface of the sixth lens 260, other than the paraxial region, may have a convex shape.

The seventh lens 270 may have a positive refractive power. An object-side surface of the seventh lens 270 may have a convex shape in a paraxial region thereof, and an image-side surface of the seventh lens 270 may have a concave shape in a paraxial region thereof.

In addition, either one or both of the object-side surface and the image-side surface of the seventh lens 270 may have at least one inflection point. For example, a paraxial region of the object-side surface of the seventh lens 270 may have a convex shape, and a portion of the object-side surface of the seventh lens 270, other than the paraxial region, may have a concave shape. In addition, a paraxial region of the image-side surface of the seventh lens 270 may have a concave shape, and a portion of the image-side surface of the seventh lens 270, other than the paraxial region, may have a convex shape.

The eighth lens 280 may have a negative refractive power. Both an object-side surface and an image-side surface of the eighth lens 280 may have a concave shape in respective paraxial regions thereof.

In addition, either one or both of the object-side surface and the image-side surface of the eighth lens 280 may have at least one inflection point. For example, a paraxial region of the object-side surface of the eighth lens 280 may have a concave shape, and a portion of the object-side surface of the eighth lens 280, other than the paraxial region, may have a convex shape. In addition, a paraxial region of the image-side surface of the eighth lens 280 may have a concave shape, and a portion of the image-side surface of the eighth lens 280, other than the paraxial region, may have a convex shape.

Each surface of each of the first to eighth lenses 210 to 280 may have a conic constant K and aspherical surface coefficients A to H, J, and L to P according to Equation 1 discussed above as listed in Table 4 below. Accordingly, the object-side surfaces and the image-side surfaces of the first lens 210 to the eighth lens 280 may all be aspherical surfaces.

TABLE 4

| | S1 | S2 | S3 | S4 | S5 | S6 |
|---|---|---|---|---|---|---|
| K | −1.207E+00 | 1.125E+01 | 4.083E+00 | −8.163E−01 | −7.970E+00 | −2.175E+00 |
| A | 2.664E−03 | 4.159E−03 | 2.113E−03 | −2.653E−03 | −1.543E−03 | 1.488E−04 |
| B | 9.856E−03 | −1.015E−02 | −1.249E−02 | 1.438E−02 | −1.778E−02 | −2.826E−02 |
| C | −2.244E−02 | 1.694E−02 | 2.829E−02 | −5.552E−02 | 5.459E−02 | 1.006E−01 |
| D | 3.335E−02 | −2.530E−02 | −4.625E−02 | 1.289E−01 | −1.081E−01 | −2.371E−01 |
| E | −3.348E−02 | 2.916E−02 | 5.486E−02 | −1.926E−01 | 1.431E−01 | 3.823E−01 |
| F | 2.354E−02 | −2.414E−02 | −4.607E−02 | 1.982E−01 | −1.325E−01 | −4.388E−01 |
| G | −1.187E−02 | 1.421E−02 | 2.752E−02 | −1.451E−01 | 8.855E−02 | 3.663E−01 |
| H | 4.348E−03 | −5.984E−03 | −1.178E−02 | 7.678E−02 | −4.348E−02 | −2.239E−01 |
| J | −1.157E−03 | 1.806E−03 | 3.622E−03 | −2.943E−02 | 1.574E−02 | 9.993E−02 |
| L | 2.212E−04 | −3.873E−04 | −7.918E−04 | 8.093E−03 | −4.169E−03 | −3.213E−02 |
| M | −2.960E−05 | 5.764E−05 | 1.201E−04 | −1.555E−03 | 7.867E−04 | 7.230E−03 |
| N | 2.627E−06 | −5.656E−06 | −1.199E−05 | 1.980E−04 | −1.003E−04 | −1.079E−03 |
| O | −1.389E−07 | 3.292E−07 | 7.092E−07 | −1.503E−05 | 7.757E−06 | 9.592E−05 |
| P | 3.306E−09 | −8.602E−09 | −1.879E−08 | 5.139E−07 | −2.745E−07 | −3.837E−06 |

| | S8 | S9 | S10 | S11 | S12 | S13 |
|---|---|---|---|---|---|---|
| K | −9.000E+01 | 8.999E+01 | 5.498E+01 | −9.000E+01 | −1.623E+01 | −8.276E+01 |
| A | 1.636E−02 | 3.162E−02 | 1.318E−02 | −1.360E−02 | −1.355E−02 | −5.641E−02 |
| B | −6.670E−02 | −8.385E−02 | −7.204E−02 | −1.957E−02 | −3.681E−03 | 3.040E−02 |
| C | 1.403E−01 | 1.150E−01 | 9.019E−02 | 4.425E−02 | 1.901E−02 | −1.384E−02 |
| D | −2.286E−01 | −1.236E−01 | −7.428E−02 | −6.789E−02 | −2.715E−02 | 4.973E−03 |
| E | 2.693E−01 | 1.078E−01 | 4.172E−02 | 7.010E−02 | 2.255E−02 | −1.615E−03 |
| F | −2.320E−01 | −7.837E−02 | −1.448E−02 | −4.985E−02 | −1.270E−02 | 4.818E−04 |
| G | 1.468E−01 | 4.644E−02 | 1.401E−03 | 2.503E−02 | 5.070E−03 | −1.235E−04 |
| H | −6.792E−02 | −2.166E−02 | 1.476E−03 | −8.991E−03 | −1.459E−03 | 2.492E−05 |
| J | 2.266E−02 | 7.691E−03 | −9.124E−04 | 2.317E−03 | 3.027E−04 | −3.701E−06 |
| L | −5.298E−03 | −2.012E−03 | 2.717E−04 | −4.243E−04 | −4.471E−05 | 3.877E−07 |
| M | 8.242E−04 | 3.721E−04 | −4.871E−05 | 5.377E−05 | 4.569E−06 | −2.765E−08 |
| N | −7.688E−05 | −4.574E−05 | 5.328E−06 | −4.473E−06 | −3.062E−07 | 1.274E−09 |
| O | 3.328E−06 | 3.338E−06 | −3.284E−07 | 2.194E−07 | 1.206E−08 | −3.417E−11 |
| P | −1.154E−08 | −1.091E−07 | 8.768E−09 | −4.797E−09 | −2.115E−10 | 4.051E−13 |

| | S14 | S15 | S16 | S17 |
|---|---|---|---|---|
| K | −9.657E−01 | −8.464E−01 | −1.914E+01 | −2.002E+00 |
| A | −4.329E−02 | 6.488E−03 | −6.437E−02 | −5.976E−02 |
| B | 1.339E−02 | −6.736E−03 | 2.360E−02 | 2.119E−02 |
| C | −4.997E−03 | 2.443E−03 | −6.354E−03 | −5.714E−03 |
| D | 1.323E−03 | −7.953E−04 | 1.196E−03 | 1.130E−03 |
| E | −2.671E−04 | 1.802E−04 | −1.513E−04 | −1.653E−04 |
| F | 3.873E−05 | −2.695E−05 | 1.297E−05 | 1.797E−05 |
| G | −3.730E−06 | 2.554E−06 | −7.555E−07 | −1.454E−06 |
| H | 2.144E−07 | −1.249E−07 | 2.909E−08 | 8.725E−08 |
| J | −4.271E−09 | −1.673E−09 | −6.581E−10 | −3.856E−09 |
| L | −3.631E−10 | 7.165E−10 | 3.878E−12 | 1.234E−10 |
| M | 3.528E−11 | −5.142E−11 | 2.441E−13 | −2.780E−12 |
| N | −1.429E−12 | 1.904E−12 | −7.967E−15 | 4.171E−14 |
| O | 2.989E−14 | −3.751E−14 | 1.054E−16 | −3.740E−16 |
| P | −2.636E−16 | 3.115E−16 | −5.503E−19 | 1.515E−18 |

In addition, the optical imaging system configured as described above may have aberration properties as illustrated in FIG. 4.

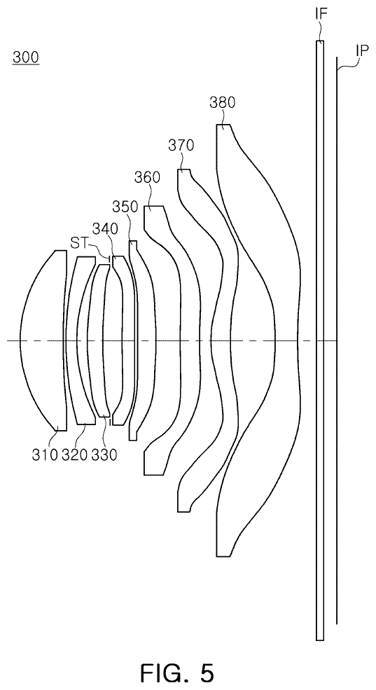

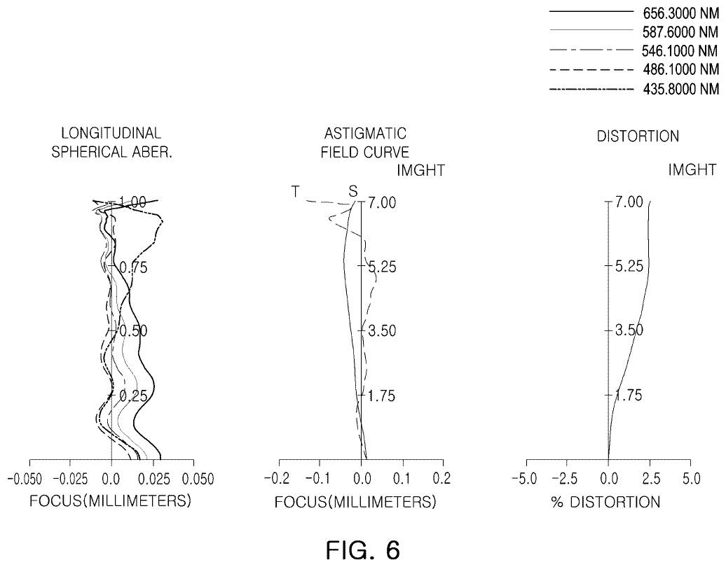

FIG. 5 is a block diagram illustrating an optical imaging system according to a third embodiment of the present disclosure, and FIG. 6 is a diagram illustrating aberration properties of the optical imaging system illustrated in FIG. 5.

Referring to FIG. 5, an optical imaging system 300 according to the third embodiment of the present disclosure may include a first lens 310, a second lens 320, a third lens 330, a fourth lens 340, a fifth lens 350, a sixth lens 360, a seventh lens 370, and an eighth lens 380 sequentially disposed in ascending numerical order along an optical axis of the optical imaging system 300 from an object side of the optical imaging system 300 toward an imaging plane IP of the optical imaging system 300, and may further include a filter F and an image sensor (not shown) that may include the imaging plane IP.

The optical imaging system 300 may further include a stop ST. The stop ST may be disposed between the third lens 330 and the fourth lens 340. For example, the stop ST may be disposed closer to an image-side surface of the third lens 330 than to an object-side surface of the fourth lens 340.

The optical imaging system 300 according to the third embodiment of the present disclosure may form a focal point on the imaging plane IP.

Lens properties (a radius of curvature, a thickness of a lens or a distance between lenses, a refractive index, an Abbe number, and an effective radius) of each lens are listed in Table 5 below.

TABLE 5

| Surface | | Radius of | Thickness/ | Refractive | Abbe | Effective |
|---|---|---|---|---|---|---|
| No. | Element | Curvature | Distance | Index | Number | Radius |
| S1 | First | 3.089 | 1.194 | 1.546 | 55.990 | 2.360 |
| S2 | Lens | 15.499 | 0.056 | | | 2.296 |
| S3 | Second | 8.827 | 0.310 | 1.679 | 19.238 | 2.192 |
| S4 | Lens | 4.680 | 0.290 | | | 2.007 |
| S5 | Third | 7.884 | 0.416 | 1.546 | 55.990 | 1.986 |
| S6 | Lens | 10.556 | 0.238 | | | 1.937 |
| S7 | Stop | Infinity | 0.302 | | | 1.939 |
| S8 | Fourth | 22.401 | 0.310 | 1.679 | 19.238 | 1.941 |
| S9 | Lens | 13.883 | 0.101 | | | 2.200 |
| S10 | Fifth | 47.295 | 0.503 | 1.546 | 55.990 | 2.384 |
| S11 | Lens | −53.370 | 0.662 | | | 2.532 |
| S12 | Sixth | 13.541 | 0.530 | 1.571 | 37.403 | 2.916 |
| S13 | Lens | 7.853 | 0.314 | | | 3.470 |
| S14 | Seventh | 2.684 | 0.530 | 1.546 | 55.990 | 4.232 |
| S15 | Lens | 7.365 | 1.223 | | | 4.467 |
| S16 | Eighth | −8.607 | 0.610 | 1.537 | 55.730 | 5.463 |
| S17 | Lens | 4.466 | 0.534 | | | 5.646 |
| S18 | Filter | Infinity | 0.110 | 1.518 | 64.197 | |
| S19 | | Infinity | 0.437 | | | |
| S20 | Imaging | Infinity | | | | |
| | Plane | | | | | |

In the third embodiment of the present disclosure, the first lens 310 may have a positive refractive power. An object-side surface of the first lens 310 may have a convex shape in a paraxial region thereof, and an image-side surface of the first lens 310 may have a concave shape in a paraxial region thereof.

The second lens 320 may have a negative refractive power. An object-side surface of the second lens 320 may have a convex shape in a paraxial region thereof, and an image-side surface of the second lens 320 may have a concave shape in a paraxial region thereof.

The third lens 330 may have a positive refractive power. An object-side surface of the third lens 330 may have a convex shape in a paraxial region thereof, and an image-side surface of the third lens 330 may have a concave shape in a paraxial region thereof.

The fourth lens 340 may have a negative refractive power. An object-side surface of the fourth lens 340 may have a convex shape in a paraxial region thereof, and an image-side surface of the fourth lens 340 may have a concave shape in a paraxial region thereof.

The fifth lens 350 may have a positive refractive power. Both an object-side surface and an image-side surface of the fifth lens 350 may have a convex shape in respective paraxial regions thereof.

The sixth lens 360 may have a negative refractive power. An object-side surface of the sixth lens 360 may have a convex shape in a paraxial region thereof, and an image-side surface of the sixth lens 360 may have a concave shape in a paraxial region thereof.

In addition, either one or both of the object-side surface and the image-side surface of the sixth lens 360 may have at least one inflection point. For example, a paraxial region of the object-side surface of the sixth lens 360 may have a convex shape, and a portion of the object-side surface of the sixth lens 360, other than the paraxial region, may have a concave shape. In addition, a paraxial region of the image-side surface of the sixth lens 360 may have a concave shape, and a portion of the image-side surface of the sixth lens 360, other than the paraxial region, may have a convex shape.

The seventh lens 370 may have a positive refractive power. An object-side surface of the seventh lens 370 may have a convex shape in a paraxial region thereof, and an image-side surface of the seventh lens 370 may have a concave shape in a paraxial region thereof.

In addition, either one or both of the object-side surface and the image-side surface of the seventh lens 370 may have at least one inflection point. For example, a paraxial region of the object-side surface of the seventh lens 370 may have a convex shape, and a portion of the object-side surface of the seventh lens 370, other than the paraxial region, may have a concave shape. In addition, a paraxial region of the image-side surface of the seventh lens 370 may have a concave shape, and a portion of the image-side surface of the seventh lens 370, other than the paraxial region, may have a convex shape.

The eighth lens 380 may have a negative refractive power. Both an object-side surface and an image-side surface of the eighth lens 380 may have a concave shape in respective paraxial regions thereof.

In addition, either one or both of the object-side surface and the image-side surface of the eighth lens 380 may have at least one inflection point. For example, a paraxial region of the object-side surface of the eighth lens 380 may have a concave shape, and a portion of the object-side surface of the eighth lens 380, other than the paraxial region, may have a convex shape. In addition, a paraxial region of the image-side surface of the eighth lens 380 may have a concave shape, and a portion of the image-side surface of the eighth lens 380, other than the paraxial region, may have a convex shape.

Each surface of each of the first to eighth lenses 330 to 380 may have a conic constant K and aspherical surface coefficients A to H, J, and L to P according to Equation 1 discussed above as listed in Table 6 below. Accordingly, the object-side surfaces and the image-side surfaces of the first lens 330 to the eighth lens 380 may all be aspherical surfaces.

TABLE 6

| | S1 | S2 | S3 | S4 | S5 | S6 |
|---|---|---|---|---|---|---|
| K | −1.326E+00 | 2.660E+00 | 9.568E−01 | −9.326E−01 | 6.194E−01 | 7.675E+00 |
| A | 3.917E−03 | 1.762E−02 | 1.753E−02 | 4.589E−03 | 3.941E−03 | −2.812E−03 |
| B | 2.568E−03 | −4.163E−02 | −4.444E−02 | 6.402E−04 | −4.197E−02 | −1.412E−02 |
| C | −3.120E−03 | 6.114E−02 | 6.983E−02 | −2.941E−02 | 1.479E−01 | 7.557E−02 |
| D | 4.247E−03 | −7.149E−02 | −8.947E−02 | 7.915E−02 | −3.324E−01 | −2.289E−01 |
| E | −5.372E−03 | 6.485E−02 | 8.931E−02 | −1.194E−01 | 4.967E−01 | 4.352E−01 |
| F | 4.944E−03 | −4.435E−02 | −6.624E−02 | 1.201E−01 | −5.142E−01 | −5.571E−01 |
| G | −3.131E−03 | 2.259E−02 | 3.604E−02 | −8.476E−02 | 3.792E−01 | 4.993E−01 |
| H | 1.373E−03 | −8.530E−03 | −1.436E−02 | 4.287E−02 | −2.019E−01 | −3.194E−01 |
| J | −4.208E−04 | 2.368E−03 | 4.164E−03 | −1.560E−02 | 7.781E−02 | 1.466E−01 |
| L | 8.995E−05 | −4.761E−04 | −8.681E−04 | 4.051E−03 | −2.150E−02 | −4.787E−02 |
| M | −1.315E−05 | 6.729E−05 | 1.264E−04 | −7.314E−04 | 4.151E−03 | 1.086E−02 |
| N | 1.253E−06 | −6.334E−06 | −1.219E−05 | 8.715E−05 | −5.316E−04 | −1.624E−03 |
| O | −7.020E−08 | 3.560E−07 | 6.991E−07 | −6.152E−06 | 4.057E−05 | 1.441E−04 |
| P | 1.753E−09 | −9.035E−09 | −1.801E−08 | 1.946E−07 | −1.396E−06 | −5.738E−06 |

| | S8 | S9 | S10 | S11 | S12 | S13 |
|---|---|---|---|---|---|---|
| K | −8.997E+01 | −9.000E+01 | 9.000E+01 | −3.393E+01 | −5.250E+01 | −7.338E+01 |
| A | −7.776E−04 | −6.473E−03 | −2.036E−02 | −1.552E−02 | −1.855E−02 | −5.338E−02 |
| B | −5.211E−02 | −9.537E−03 | −2.732E−04 | −2.175E−02 | −8.166E−04 | 2.421E−02 |
| C | 1.753E−01 | 2.742E−02 | 4.008E−03 | 5.842E−02 | 2.085E−02 | −9.379E−03 |
| D | −4.124E−01 | −6.235E−02 | −2.493E−03 | −9.206E−02 | −3.233E−02 | 3.224E−03 |
| E | 6.650E−01 | 9.241E−02 | −2.988E−03 | 9.445E−02 | 2.788E−02 | −1.257E−03 |
| F | −7.580E−01 | −9.339E−02 | 8.172E−03 | −6.637E−02 | −1.604E−02 | 4.774E−04 |
| G | 6.215E−01 | 6.601E−02 | −8.569E−03 | 3.291E−02 | 6.474E−03 | −1.435E−04 |
| H | −3.699E−01 | −3.325E−02 | 5.233E−03 | −1.168E−02 | −1.868E−03 | 3.121E−05 |
| J | 1.597E−01 | 1.202E−02 | −2.033E−03 | 2.976E−03 | 3.865E−04 | −4.752E−06 |
| L | −4.953E−02 | −3.089E−03 | 5.169E−04 | −5.384E−04 | −5.670E−05 | 4.983E−07 |
| M | 1.074E−02 | 5.505E−04 | −8.587E−05 | 6.741E−05 | 5.743E−06 | −3.516E−08 |
| N | −1.544E−03 | −6.449E−05 | 8.985E−06 | −5.543E−06 | −3.809E−07 | 1.595E−09 |
| O | 1.324E−04 | 4.457E−06 | −5.381E−07 | 2.688E−07 | 1.485E−08 | −4.199E−11 |
| P | −5.118E−06 | −1.375E−07 | 1.408E−08 | −5.815E−09 | −2.578E−10 | 4.882E−13 |

| | S14 | S15 | S16 | S17 |
|---|---|---|---|---|
| K | −9.887E−01 | −8.381E−01 | −2.937E+01 | −2.448E+00 |
| A | −3.847E−02 | 1.485E−02 | −6.305E−02 | −6.002E−02 |
| B | 1.030E−02 | −7.850E−03 | 2.260E−02 | 2.139E−02 |
| C | −4.611E−03 | 5.261E−05 | −6.623E−03 | −6.013E−03 |
| D | 1.391E−03 | 7.436E−04 | 1.391E−03 | 1.240E−03 |
| E | −2.602E−04 | −2.985E−04 | −1.938E−04 | −1.868E−04 |
| F | 2.202E−05 | 6.680E−05 | 1.819E−05 | 2.073E−05 |
| G | 1.463E−06 | −9.996E−06 | −1.177E−06 | −1.706E−06 |
| H | −6.221E−07 | 1.065E−06 | 5.282E−08 | 1.041E−07 |
| J | 7.921E−08 | −8.274E−08 | −1.616E−09 | −4.679E−09 |
| L | −5.813E−09 | 4.666E−09 | 3.167E−11 | 1.524E−10 |
| M | 2.692E−10 | −1.860E−10 | −3.236E−13 | −3.490E−12 |
| N | −7.806E−12 | 4.946E−12 | −1.957E−16 | 5.318E−14 |
| O | 1.301E−13 | −7.846E−14 | 4.134E−17 | −4.832E−16 |
| P | −9.550E−16 | 5.594E−16 | −3.100E−19 | 1.980E−18 |

In addition, the optical imaging system configured as described above may have aberration properties as illustrated in FIG. 6.

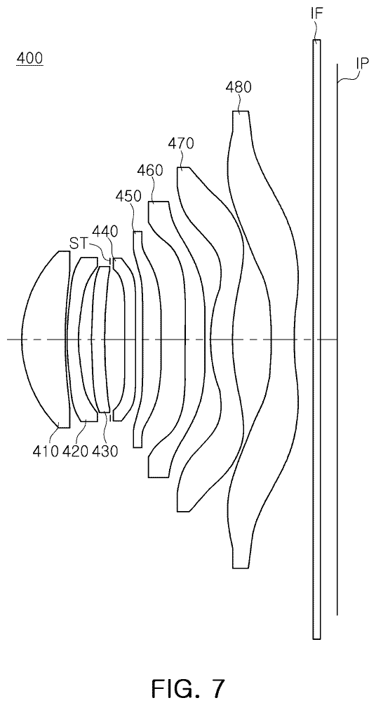

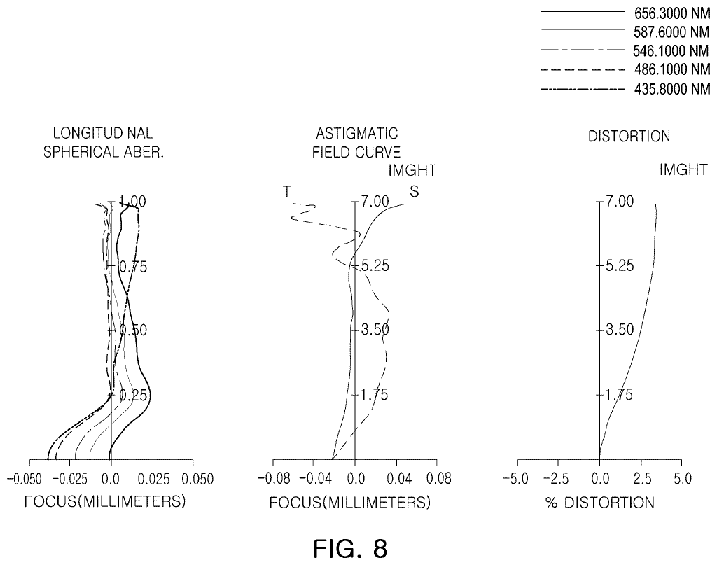

FIG. 7 is a block diagram illustrating an optical imaging system according to a fourth embodiment of the present disclosure, and FIG. 8 is a diagram illustrating aberration properties of the optical imaging system illustrated in FIG. 7.

Referring to FIG. 7, an optical imaging system 400 according to the fourth embodiment of the present disclosure may include a first lens 410, a second lens 420, a third lens 430, a fourth lens 440, a fifth lens 450, a sixth lens 460, a seventh lens 470, and an eighth lens 480 sequentially disposed in ascending numerical order along an optical axis of the optical imaging system 400 from an object side of the optical imaging system 400 toward an imaging plane IP of the optical imaging system 400, and may further include a filter F and an image sensor (not shown) that may include the imaging plane IP.

The optical imaging system 400 may further include a stop ST. The stop ST may be disposed between the third lens 430 and the fourth lens 440. For example, the stop ST may be disposed closer to an image-side surface of the third lens 430 than to an object-side surface of the fourth lens 440.

The optical imaging system 400 according to the fourth embodiment of the present disclosure may form a focal point on the imaging plane IP.

Lens properties (a radius of curvature, a thickness of a lens or a distance between lenses, a refractive index, an Abbe number, and an effective radius) of each lens are listed in Table 7 below.

TABLE 7

| Surface | | Radius of | Thickness/ | Refractive | Abbe | Effective |
|---|---|---|---|---|---|---|
| No. | Element | Curvature | Distance | Index | Number | Radius |
| S1 | First | 2.946 | 1.195 | 1.546 | 55.990 | 2.329 |
| S2 | Lens | 9.410 | 0.061 | | | 2.259 |
| S3 | Second | 8.155 | 0.300 | 1.679 | 19.238 | 2.158 |
| S4 | Lens | 4.871 | 0.349 | | | 1.948 |
| S5 | Third | 7.826 | 0.392 | 1.546 | 55.990 | 1.933 |
| S6 | Lens | 11.564 | 0.165 | | | 1.838 |
| S7 | Stop | Infinity | 0.361 | | | 1.820 |
| S8 | Fourth | 22.951 | 0.300 | 1.695 | 18.408 | 1.873 |
| S9 | Lens | 15.219 | 0.210 | | | 2.143 |
| S10 | Fifth | 27.017 | 0.500 | 1.546 | 55.990 | 2.672 |
| S11 | Lens | −266.407 | 0.668 | | | 2.851 |
| S12 | Sixth | −207.809 | 0.520 | 1.571 | 37.403 | 3.122 |
| S13 | Lens | 10.921 | 0.165 | | | 3.656 |
| S14 | Seventh | 2.365 | 0.600 | 1.546 | 55.990 | 4.283 |
| S15 | Lens | 6.050 | 1.069 | | | 4.559 |
| S16 | Eighth | −24.893 | 0.600 | 1.537 | 55.730 | 5.794 |
| S17 | Lens | 3.731 | 0.534 | | | 6.021 |
| S18 | Filter | Infinity | 0.210 | 1.518 | 64.197 | |
| S19 | | Infinity | 0.482 | | | |
| S20 | Imaging | Infinity | | | | |
| | Plane | | | | | |

In the fourth embodiment of the present disclosure, the first lens 440 may have a positive refractive power. An object-side surface of the first lens 440 may have a convex shape in a paraxial region thereof, and an image-side surface of the first lens 440 may have a concave shape in a paraxial region thereof.

The second lens 420 may have a negative refractive power. An object-side surface of the second lens 420 may have a convex shape in a paraxial region thereof, and an image-side surface of the second lens 420 may have a concave shape in a paraxial region thereof.

The third lens 430 may have a positive refractive power. An object-side surface of the third lens 430 may have a convex shape in a paraxial region thereof, and an image-side surface of the third lens 430 may have a concave shape in a paraxial region thereof.

The fourth lens 440 may have a negative refractive power. An object-side surface of the fourth lens 440 may have a convex shape in a paraxial region thereof, and an image-side surface of the fourth lens 440 may have a concave shape in a paraxial region thereof.

The fifth lens 450 may have a positive refractive power. Both an object-side surface and an image-side surface of the fifth lens 450 may have a convex shape in respective paraxial regions thereof.

The sixth lens 460 may have a negative refractive power. Both an object-side surface and an image-side surface of the sixth lens 460 may have a concave shape in respective paraxial regions thereof.

In addition, either one or both of the object-side surface and the image-side surface of the sixth lens 460 may have at least one inflection point. For example, a paraxial region of the object-side surface of the sixth lens 460 may have a concave shape, and a portion of the object-side surface of the sixth lens 460, other than the paraxial region, may have a convex shape. In addition, a paraxial region of the image-side surface of the sixth lens 460 may have a concave shape, and a portion of the image-side surface of the sixth lens 460, other than the paraxial region, may have a convex shape.

The seventh lens 470 may have a positive refractive power. An object-side surface of the seventh lens 470 may have a convex shape in a paraxial region thereof, and an image-side surface of the seventh lens 470 may have a concave shape in a paraxial region thereof.

In addition, either one or both of the object-side surface and the image-side surface of the seventh lens 470 may have at least one inflection point. For example, a paraxial region of the object-side surface of the seventh lens 470 may have a convex shape, and a portion of the object-side surface of the seventh lens 470, other than the paraxial region, may have a concave shape. In addition, a paraxial region of the image-side surface of the seventh lens 470 may have a concave shape, and a portion of the image-side surface of the seventh lens 470, other than the paraxial region, may have a convex shape.

The eighth lens 480 may have a negative refractive power. Both an object-side surface and an image-side surface of the eighth lens 480 may have a concave shape in respective paraxial regions thereof.

In addition, either one or both of the object-side surface and the image-side surface of the eighth lens 480 may have at least one inflection point. For example, a paraxial region of the object-side surface of the eighth lens 480 may have a concave shape, and a portion of the object-side surface of the eighth lens 480, other than the paraxial region, may have a convex shape. In addition, a paraxial region of the image-side surface of the eighth lens 480 may have a concave shape, and a portion of the image-side surface of the eighth lens 480, other than the paraxial region, may have a convex shape.

Each surface of each of the first to eighth lenses 440 to 480 may have a conic constant K and aspherical surface coefficients A to H, J, and L to P according to Equation 1 discussed above as listed in Table 8 below. Accordingly, the object-side surfaces and the image-side surfaces of the first lens 440 to the eighth lens 480 may all be aspherical surfaces.

TABLE 8

| | S1 | S2 | S3 | S4 | S5 | S6 |
|---|---|---|---|---|---|---|
| K | −1.153E+00 | −1.157E+01 | 6.062E−01 | 3.465E−01 | −9.709E+00 | −2.119E+01 |
| A | 5.322E−03 | −1.390E−02 | −1.984E−02 | −1.216E−02 | −6.707E−03 | −3.127E−05 |
| B | −6.873E−04 | 1.235E−02 | 1.620E−02 | 3.413E−02 | 3.660E−03 | −2.861E−02 |
| C | 3.942E−03 | −9.976E−03 | −4.324E−03 | −9.494E−02 | 5.480E−03 | 1.068E−01 |
| D | −6.343E−03 | 1.114E−02 | −6.075E−03 | 2.125E−01 | −3.833E−02 | −2.562E−01 |
| E | 6.166E−03 | −1.300E−02 | 1.092E−02 | −3.299E−01 | 8.460E−02 | 4.123E−01 |
| F | −4.081E−03 | 1.125E−02 | −9.948E−03 | 3.585E−01 | −1.098E−01 | −4.635E−01 |
| G | 1.932E−03 | −6.794E−03 | 6.221E−03 | −2.782E−01 | 9.495E−02 | 3.731E−01 |
| H | −6.697E−04 | 2.894E−03 | −2.812E−03 | 1.560E−01 | −5.740E−02 | −2.177E−01 |
| J | 1.708E−04 | −8.776E−04 | 9.248E−04 | −6.338E−02 | 2.467E−02 | 9.221E−02 |
| L | −3.175E−05 | 1.887E−04 | −2.186E−04 | 1.846E−02 | −7.521E−03 | −2.804E−02 |
| M | 4.197E−06 | −2.814E−05 | 3.615E−05 | −3.758E−03 | 1.592E−03 | 5.960E−03 |
| N | −3.742E−07 | 2.770E−06 | −3.966E−06 | 5.071E−04 | −2.228E−04 | −8.397E−04 |
| O | 2.022E−08 | −1.619E−07 | 2.595E−07 | −4.075E−05 | 1.855E−05 | 7.037E−05 |
| P | −5.008E−10 | 4.254E−09 | −7.674E−09 | 1.474E−06 | −6.963E−07 | −2.651E−06 |

| | S8 | S9 | S10 | S11 | S12 | S13 |
|---|---|---|---|---|---|---|
| K | −6.702E+01 | −2.037E+01 | 4.058E+01 | −5.178E+01 | −9.000E+01 | −5.590E+01 |
| A | −1.928E−02 | −1.423E−02 | −1.396E−02 | −1.267E−02 | −1.389E−03 | −8.056E−02 |
| B | 2.803E−02 | −4.194E−03 | −1.151E−02 | −7.102E−03 | −8.068E−03 | 3.654E−02 |
| C | −1.198E−01 | 4.111E−03 | 1.664E−02 | 5.672E−03 | 1.473E−02 | −8.127E−03 |
| D | 2.973E−01 | −7.199E−03 | −1.619E−02 | −3.415E−03 | −1.592E−02 | −2.068E−03 |
| E | −4.982E−01 | 1.492E−02 | 1.128E−02 | 9.854E−04 | 1.074E−02 | 2.452E−03 |
| F | 5.867E−01 | −2.187E−02 | −5.364E−03 | 3.660E−04 | −4.979E−03 | −1.021E−03 |
| G | −4.979E−01 | 2.055E−02 | 1.621E−03 | −5.095E−04 | 1.652E−03 | 2.602E−04 |
| H | 3.079E−01 | −1.284E−02 | −2.670E−04 | 2.483E−04 | −3.989E−04 | −4.466E−05 |
| J | −1.387E−01 | 5.488E−03 | 6.170E−06 | −7.134E−05 | 7.022E−05 | 5.322E−06 |
| L | 4.502E−02 | −1.613E−03 | 6.896E−06 | 1.322E−05 | −8.900E−06 | −4.419E−07 |
| M | −1.024E−02 | 3.212E−04 | −1.497E−06 | −1.598E−06 | 7.887E−07 | 2.511E−08 |
| N | 1.548E−03 | −4.141E−05 | 1.499E−07 | 1.218E−07 | −4.621E−08 | −9.322E−10 |
| O | −1.396E−04 | 3.119E−06 | −7.626E−09 | −5.316E−09 | 1.603E−09 | 2.038E−11 |
| P | 5.683E−06 | −1.042E−07 | 1.582E−10 | 1.012E−10 | −2.485E−11 | −1.990E−13 |

| | S14 | S15 | S16 | S17 |
|---|---|---|---|---|
| K | −9.996E−01 | −1.970E+00 | −9.000E+01 | −1.150E+00 |
| A | −6.146E−02 | 3.366E−02 | −5.352E−02 | −6.009E−02 |
| B | 1.946E−02 | −2.489E−02 | 1.754E−02 | 1.924E−02 |
| C | −8.073E−03 | 8.715E−03 | −5.012E−03 | −5.371E−03 |
| D | 2.244E−03 | −2.281E−03 | 1.210E−03 | 1.134E−03 |
| E | −3.671E−04 | 4.848E−04 | −2.084E−04 | −1.739E−04 |
| F | 2.160E−05 | −8.470E−05 | 2.472E−05 | 1.922E−05 |
| G | 3.880E−06 | 1.186E−05 | −2.053E−06 | −1.532E−06 |
| H | −1.036E−06 | −1.282E−06 | 1.215E−07 | 8.820E−08 |
| J | 1.166E−07 | 1.034E−07 | −5.160E−09 | −3.663E−09 |
| L | −7.873E−09 | −6.036E−09 | 1.565E−10 | 1.085E−10 |
| M | 3.391E−10 | 2.455E−10 | −3.311E−12 | −2.236E−12 |
| N | −9.170E−12 | −6.565E−12 | 4.645E−14 | 3.044E−14 |
| O | 1.425E−13 | 1.035E−13 | −3.887E−16 | −2.460E−16 |
| P | −9.729E−16 | −7.281E−16 | 1.468E−18 | 8.936E−19 |

In addition, the optical imaging system configured as described above may have aberration properties as illustrated in FIG. 8.

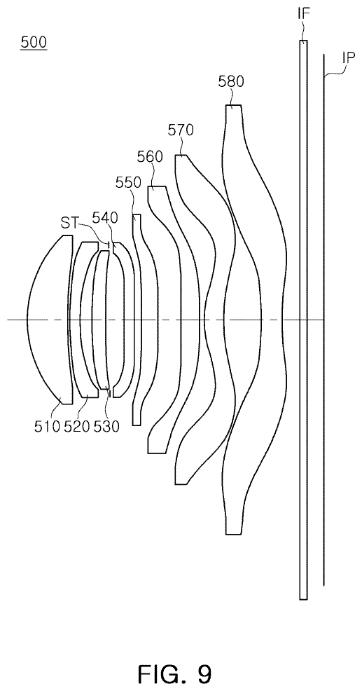

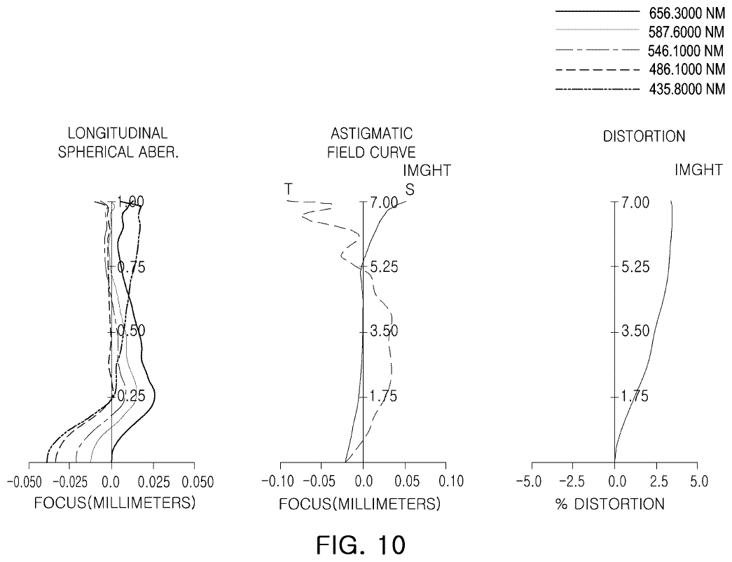

FIG. 9 is a block diagram illustrating an optical imaging system according to a fifth embodiment of the present disclosure, and FIG. 10 is a diagram illustrating aberration properties of the optical imaging system illustrated in FIG. 9.

Referring to FIG. 9, an optical imaging system 500 according to the fifth embodiment of the present disclosure may include a first lens 510, a second lens 520, a third lens 530, a fourth lens 540, a fifth lens 550, a sixth lens 560, a seventh lens 570, and an eighth lens 580 sequentially disposed in ascending numerical order along an optical axis of the optical imaging system 500 from an object side of the optical imaging system 500 toward an imaging plane IP of the optical imaging system 500, and may further include a filter F and an image sensor (not shown) that may include the imaging plane IP.

The optical imaging system 500 may further include a stop ST. The stop ST may be disposed between the third lens 530 and the fourth lens 540. For example, the stop ST may be disposed closer to an image-side surface of the third lens 530 than to an object-side surface of the fourth lens 540.

The optical imaging system 500 according to the fifth embodiment of the present disclosure may form a focal point on the imaging plane IP.

Lens properties (a radius of curvature, a thickness of a lens or a distance between lenses, a refractive index, an Abbe number, and an effective radius) of each lens are listed in Table 9 below.

TABLE 9

| Surface | | Radius of | Thickness/ | Refractive | Abbe | Effective |
|---|---|---|---|---|---|---|
| No. | Element | Curvature | Distance | Index | Number | Radius |
| S1 | First | 2.949 | 1.190 | 1.546 | 55.990 | 2.329 |
| S2 | Lens | 9.254 | 0.062 | | | 2.260 |
| S3 | Second | 8.115 | 0.300 | 1.679 | 19.238 | 2.158 |
| S4 | Lens | 4.871 | 0.346 | | | 1.950 |
| S5 | Third | 7.750 | 0.390 | 1.546 | 55.990 | 1.935 |
| S6 | Lens | 11.186 | 0.172 | | | 1.839 |
| S7 | Stop | Infinity | 0.368 | | | 1.822 |
| S8 | Fourth | 23.378 | 0.300 | 1.695 | 18.408 | 1.876 |
| S9 | Lens | 15.301 | 0.210 | | | 2.150 |
| S10 | Fifth | 25.611 | 0.500 | 1.546 | 55.990 | 2.728 |
| S11 | Lens | −984.856 | 0.669 | | | 2.931 |
| S12 | Sixth | 168.443 | 0.520 | 1.571 | 37.403 | 3.268 |
| S13 | Lens | 10.669 | 0.165 | | | 3.743 |
| S14 | Seventh | 2.320 | 0.550 | 1.546 | 55.990 | 4.328 |
| S15 | Lens | 5.649 | 1.110 | | | 4.605 |
| S16 | Eighth | −25.207 | 0.600 | 1.537 | 55.730 | 5.803 |
| S17 | Lens | 3.713 | 0.534 | | | 6.014 |
| S18 | Filter | Infinity | 0.210 | 1.518 | 64.197 | |
| S19 | | Infinity | 0.485 | | | |
| S20 | Imaging | Infinity | | | | |
| | Plane | | | | | |

In the fifth embodiment of the present disclosure, the first lens 510 may have a positive refractive power. An object-side surface of the first lens 510 may have a convex shape in a paraxial region thereof, and an image-side surface of the first lens 510 may have a concave shape in a paraxial region thereof.

The second lens 520 may have a negative refractive power. An object-side surface of the second lens 520 may have a convex shape in a paraxial region thereof, and an image-side surface of the second lens 520 may have a concave shape in a paraxial region thereof.

The third lens 530 may have a positive refractive power. An object-side surface of the third lens 530 may have a convex shape in a paraxial region thereof, and an image-side surface of the third lens 530 may have a concave shape in a paraxial region thereof.

The fourth lens 540 may have a negative refractive power. An object-side surface of the fourth lens 540 may have a convex shape in a paraxial region thereof, and an image-side surface of the fourth lens 540 may have a concave shape in a paraxial region thereof.

The fifth lens 550 may have a positive refractive power. Both an object-side surface and an image-side surface of the fifth lens 550 may have a convex shape in respective paraxial regions thereof.

The sixth lens 560 may have a negative refractive power. An object-side surface of the sixth lens 560 may have a convex shape in a paraxial region thereof, and an image-side surface of the sixth lens 560 may have a concave shape in a paraxial region thereof.

In addition, either one or both of the object-side surface and the image-side surface of the sixth lens 560 may have at least one inflection point. For example, a paraxial region of the object-side surface of the sixth lens 560 may have a convex shape, and a portion of the object-side surface of the sixth lens 560, other than the paraxial region, may have a concave shape. In addition, a paraxial region of the image-side surface of the sixth lens 560 may have a concave shape, and a portion of the image-side surface of the sixth lens 560, other than the paraxial region, may have a convex shape.

The seventh lens 570 may have a positive refractive power. An object-side surface of the seventh lens 570 may have a convex shape in a paraxial region thereof, and an image-side surface of the seventh lens 570 may have a concave shape in a paraxial region thereof.

In addition, either one or both of the object-side surface and the image-side surface of the seventh lens 570 may have at least one inflection point. For example, a paraxial region of the object-side surface of the seventh lens 570 may have a convex shape, and a portion of the object-side surface of the seventh lens 570, other than the paraxial region, may have a concave shape. In addition, a paraxial region of the image-side surface of the seventh lens 570 may have a concave shape, and a portion of the image-side surface of the seventh lens 570, other than the paraxial region, may have a convex shape.

The eighth lens 580 may have a negative refractive power. Both an object-side surface and an image-side surface of the eighth lens 580 may have a concave shape in respective paraxial regions thereof.

In addition, either one or both of the object-side surface and the image-side surface of the eighth lens 580 may have at least one inflection point. For example, a paraxial region of the object-side surface of the eighth lens 580 may have a concave shape, and a portion of the object-side surface of the eighth lens 580, other than the paraxial region, may have a convex shape. In addition, a paraxial region of the image-side surface of the eighth lens 580 may have a concave shape, and a portion of the image-side surface of the eighth lens 580, other than the paraxial region, may have a convex shape.

Each surface of each of the first to eighth lenses 510 to 580 may have a conic constant K and aspherical surface coefficients A to H, J, and L to P according to Equation 1 discussed above as listed in Table 10 below. For example, the object-side surfaces and the image-side surfaces of the first lens 510 to the eighth lens 580 may all be aspherical surfaces.

TABLE 10

| | S1 | S2 | S3 | S4 | S5 | S6 |
|---|---|---|---|---|---|---|
| K | −1.159E+00 | −1.201E+01 | 5.129E−01 | 3.486E−01 | −9.688E+00 | −1.896E+01 |
| A | 5.158E−03 | −1.494E−02 | −2.093E−02 | −1.279E−02 | −7.142E−03 | −5.336E−04 |
| B | 4.371E−05 | 1.586E−02 | 2.039E−02 | 3.666E−02 | 6.163E−03 | −2.333E−02 |
| C | 2.335E−03 | −1.759E−02 | −1.409E−02 | −9.990E−02 | −3.284E−03 | 8.321E−02 |
| D | −4.235E−03 | 2.188E−02 | 8.770E−03 | 2.172E−01 | −1.962E−02 | −1.940E−01 |
| E | 4.341E−03 | −2.330E−02 | −4.442E−03 | −3.300E−01 | 5.790E−02 | 3.055E−01 |
| F | −2.983E−03 | 1.822E−02 | 1.249E−03 | 3.530E−01 | −8.292E−02 | −3.369E−01 |
| G | 1.459E−03 | −1.019E−02 | 3.382E−04 | −2.706E−01 | 7.544E−02 | 2.664E−01 |
| H | −5.212E−04 | 4.103E−03 | −5.626E−04 | 1.503E−01 | −4.700E−02 | −1.527E−01 |
| J | 1.368E−04 | −1.191E−03 | 2.987E−04 | −6.061E−02 | 2.060E−02 | 6.351E−02 |
| L | −2.613E−05 | 2.473E−04 | −9.337E−05 | 1.755E−02 | −6.367E−03 | −1.894E−02 |
| M | 3.540E−06 | −3.583E−05 | 1.863E−05 | −3.552E−03 | 1.361E−03 | 3.943E−03 |
| N | −3.227E−07 | 3.440E−06 | −2.344E−06 | 4.771E−04 | −1.919E−04 | −5.429E−04 |
| O | 1.778E−08 | −1.967E−07 | 1.703E−07 | −3.817E−05 | 1.606E−05 | 4.432E−05 |
| P | −4.478E−10 | 5.071E−09 | −5.475E−09 | 1.376E−06 | −6.052E−07 | −1.619E−06 |

| | S8 | S9 | S10 | S11 | S12 | S13 |
|---|---|---|---|---|---|---|
| K | −6.796E+01 | −1.972E+01 | 3.452E+01 | −9.000E+01 | 9.000E+01 | −4.180E+01 |
| A | −1.676E−02 | −1.278E−02 | −1.329E−02 | −1.154E−02 | −4.592E−03 | −8.483E−02 |
| B | 1.406E−02 | −6.543E−03 | −1.168E−02 | −1.206E−02 | −1.286E−03 | 4.103E−02 |
| C | −6.661E−02 | 7.561E−03 | 1.589E−02 | 1.640E−02 | 4.653E−03 | −1.119E−02 |
| D | 1.648E−01 | −1.144E−02 | −1.460E−02 | −1.757E−02 | −5.462E−03 | −4.031E−04 |
| E | −2.763E−01 | 1.847E−02 | 9.369E−03 | 1.317E−02 | 3.337E−03 | 1.770E−03 |
| F | 3.278E−01 | −2.359E−02 | −3.835E−03 | −6.798E−03 | −1.322E−03 | −8.141E−04 |
| G | −2.824E−01 | 2.076E−02 | 7.804E−04 | 2.453E−03 | 3.645E−04 | 2.137E−04 |
| H | 1.782E−01 | −1.253E−02 | 5.496E−05 | −6.257E−04 | −7.253E−05 | −3.697E−05 |
| J | −8.222E−02 | 5.250E−03 | −8.018E−05 | 1.130E−04 | 1.061E−05 | 4.393E−06 |
| L | 2.737E−02 | −1.524E−03 | 2.306E−05 | −1.428E−05 | −1.144E−06 | −3.614E−07 |
| M | −6.387E−03 | 3.010E−04 | −3.567E−06 | 1.229E−06 | 8.917E−08 | 2.026E−08 |
| N | 9.905E−04 | −3.858E−05 | 3.228E−07 | −6.828E−08 | −4.748E−09 | −7.395E−10 |
| O | −9.158E−05 | 2.892E−06 | −1.612E−08 | 2.194E−09 | 1.537E−10 | 1.585E−11 |
| P | 3.818E−06 | −9.627E−08 | 3.443E−10 | −3.077E−11 | −2.263E−12 | −1.515E−13 |

| | S14 | S15 | S16 | S17 |
|---|---|---|---|---|
| K | −1.006E+00 | −1.873E+00 | −8.628E+01 | −1.142E+00 |
| A | −5.854E−02 | 3.848E−02 | −5.273E−02 | −5.968E−02 |
| B | 1.927E−02 | −2.688E−02 | 1.700E−02 | 1.900E−02 |
| C | −8.675E−03 | 8.927E−03 | −4.678E−03 | −5.280E−03 |
| D | 2.591E−03 | −2.185E−03 | 1.092E−03 | 1.111E−03 |
| E | −4.812E−04 | 4.321E−04 | −1.837E−04 | −1.701E−04 |
| F | 4.806E−05 | −7.080E−05 | 2.144E−05 | 1.878E−05 |
| G | −5.830E−07 | 9.449E−06 | −1.758E−06 | −1.496E−06 |
| H | −4.928E−07 | −9.893E−07 | 1.030E−07 | 8.608E−08 |
| J | 6.953E−08 | 7.816E−08 | −4.336E−09 | −3.572E−09 |
| L | −5.010E−09 | −4.492E−09 | 1.305E−10 | 1.058E−10 |
| M | 2.199E−10 | 1.804E−10 | −2.744E−12 | −2.178E−12 |
| N | −5.938E−12 | −4.772E−12 | 3.828E−14 | 2.961E−14 |
| O | 9.109E−14 | 7.443E−14 | −3.187E−16 | −2.391E−16 |
| P | −6.099E−16 | −5.176E−16 | 1.199E−18 | 8.683E−19 |

In addition, the optical imaging system configured as described above may have aberration properties as illustrated in FIG. 10.

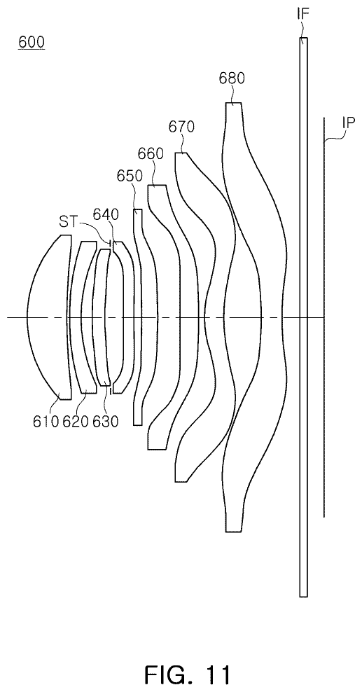

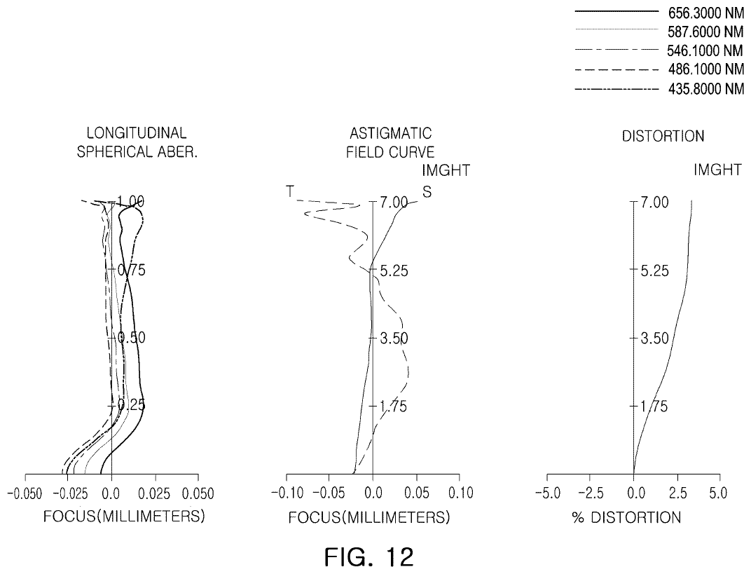

FIG. 11 is a block diagram illustrating an optical imaging system according to a sixth embodiment of the present disclosure, and FIG. 12 is a diagram illustrating aberration properties of the optical imaging system illustrated in FIG. 11.

Referring to FIG. 11, an optical imaging system 600 according to the sixth embodiment of the present disclosure may include a first lens 610, a second lens 620, a third lens 630, a fourth lens 640, a fifth lens 650, a sixth lens 660, a seventh lens 670, and an eighth lens 680 sequentially disposed in ascending numerical order along an optical axis of the optical imaging system 600 from an object side of the optical imaging system 600 toward an imaging plane IP of the optical imaging system 600, and may further include a filter F and an image sensor (not shown) that may include the imaging plane IP.

The optical imaging system 600 may further include a stop ST. The stop ST may be disposed between the third lens 630 and the fourth lens 640. For example, the stop ST may be disposed closer to an image-side surface of the third lens 630 than to an object-side surface of the fourth lens 640.

The optical imaging system 600 according to the sixth embodiment of the present disclosure may form a focal point on the imaging plane IP.

Lens properties (a radius of curvature, a thickness of a lens or a distance between lenses, a refractive index, an Abbe number, and an effective radius) of each lens are listed in Table 11 below.

TABLE 11

| Surface | | Radius of | Thickness/ | Refractive | Abbe | Effective |
|---|---|---|---|---|---|---|
| No. | Element | Curvature | Distance | Index | Number | Radius |
| S1 | First | 2.986 | 1.183 | 1.546 | 55.990 | 2.329 |
| S2 | Lens | 10.363 | 0.095 | | | 2.262 |
| S3 | Second | 9.503 | 0.300 | 1.679 | 19.238 | 2.158 |
| S4 | Lens | 5.070 | 0.315 | | | 1.965 |
| S5 | Third | 6.834 | 0.390 | 1.546 | 55.990 | 1.944 |
| S6 | Lens | 9.711 | 0.191 | | | 1.849 |
| S7 | Stop | Infinity | 0.364 | | | 1.833 |
| S8 | Fourth | 20.085 | 0.300 | 1.695 | 18.408 | 1.886 |
| S9 | Lens | 13.506 | 0.210 | | | 2.159 |
| S10 | Fifth | 21.639 | 0.500 | 1.546 | 55.990 | 2.799 |
| S11 | Lens | −333.941 | 0.660 | | | 2.997 |
| S12 | Sixth | −714.013 | 0.520 | 1.571 | 37.403 | 3.238 |
| S13 | Lens | 8.699 | 0.142 | | | 3.707 |
| S14 | Seventh | 2.259 | 0.550 | 1.546 | 55.990 | 4.354 |
| S15 | Lens | 6.374 | 1.136 | | | 4.634 |
| S16 | Eighth | −16.311 | 0.600 | 1.537 | 55.730 | 5.807 |
| S17 | Lens | 3.912 | 0.534 | | | 6.026 |
| S18 | Filter | Infinity | 0.210 | 1.518 | 64.197 | |
| S19 | | Infinity | 0.480 | | | |
| S20 | Imaging | Infinity | | | | |
| | Plane | | | | | |

In the sixth embodiment of the present disclosure, the first lens 610 may have a positive refractive power. An object-side surface of the first lens 610 may have a convex shape in a paraxial region thereof, and an image-side surface of the first lens 610 may have a concave shape in a paraxial region thereof.

The second lens 620 may have a negative refractive power. An object-side surface of the second lens 620 may have a convex shape in a paraxial region thereof, and an image-side surface of the second lens 620 may have a concave shape in a paraxial region thereof.

The third lens 630 may have a positive refractive power. An object-side surface of the third lens 630 may have a convex shape in a paraxial region thereof, and an image-side surface of the third lens 630 may have a concave shape in a paraxial region thereof.

The fourth lens 640 may have a negative refractive power. An object-side surface of the fourth lens 640 may have a convex shape in a paraxial region thereof, and an image-side surface of the fourth lens 640 may have a concave shape in a paraxial region thereof.

The fifth lens 650 may have a positive refractive power. Both an object-side surface and an image-side surface of the fifth lens 650 may have a convex shape in respective paraxial regions thereof.

The sixth lens 660 may have a negative refractive power. Both an object-side surface and an image-side surface of the sixth lens 660 may have a concave shape in respective paraxial regions thereof.

In addition, either one or both of the object-side surface and the image-side surface of the sixth lens 660 may have at least one inflection point. For example, a paraxial region of the object-side surface of the sixth lens 660 may have a concave shape, and a portion of the object-side surface of the sixth lens 660, other than the paraxial region, may have a convex shape. In addition, a paraxial region of the image-side surface of the sixth lens 660 may have a concave shape, and a portion of the image-side surface of the sixth lens 660, other than the paraxial region, may have a convex shape.

The seventh lens 670 may have a positive refractive power. An object-side surface of the seventh lens 670 may have a convex shape in a paraxial region thereof, and an image-side surface of the seventh lens 670 may have a concave shape in a paraxial region thereof.

In addition, either one or both of the object-side surface and the image-side surface of the seventh lens 670 may have at least one inflection point. For example, a paraxial region of the object-side surface of the seventh lens 670 may have a convex shape, and a portion of the object-side surface of the seventh lens 670, other than the paraxial region, may have a concave shape. In addition, a paraxial region of the image-side surface of the seventh lens 670 may have a concave shape, and a portion of the image-side surface of the seventh lens 670, other than the paraxial region, may have a convex shape.

The eighth lens 680 may have a negative refractive power. Both an object-side surface and an image-side surface of the eighth lens 680 may have a concave shape in respective paraxial regions thereof.

In addition, either one or both of the object-side surface and the image-side surface of the eighth lens 680 may have at least one inflection point. For example, a paraxial region of the object-side surface of the eighth lens 680 may have a concave shape, and a portion of the object-side surface of the eighth lens 680, other than the paraxial region, may have a convex shape. In addition, a paraxial region of the image-side surface of the eighth lens 680 may have a concave shape, and a portion of the image-side surface of the eighth lens 680, other than the paraxial region, may have a convex shape.

Each surface of each of the first to eighth lenses 610 to 680 may have a conic constant K and aspherical surface coefficients A to H, J, and L to P according to Equation 1 discussed above as listed in Table 12 below. Accordingly, the object-side surfaces and the image-side surfaces of the first lens 610 to the eighth lens 680 may all be aspherical surfaces.

TABLE 12

| | S1 | S2 | S3 | S4 | S5 | S6 |
|---|---|---|---|---|---|---|
| K | −1.225E+00 | −1.038E+01 | 9.981E−01 | −5.720E−01 | −1.340E+01 | −2.126E+01 |
| A | 4.149E−03 | −1.250E−02 | −1.936E−02 | −1.377E−02 | −8.923E−03 | −2.093E−03 |
| B | 3.439E−03 | 1.471E−02 | 1.856E−02 | 2.562E−02 | 1.412E−02 | −1.783E−02 |
| C | −4.918E−03 | −1.724E−02 | −4.511E−03 | −4.275E−02 | −3.388E−02 | 6.760E−02 |
| D | 5.285E−03 | 2.162E−02 | −1.260E−02 | 7.128E−02 | 5.623E−02 | −1.612E−01 |
| E | −3.991E−03 | −2.366E−02 | 2.298E−02 | −9.246E−02 | −6.600E−02 | 2.543E−01 |
| F | 2.088E−03 | 1.930E−02 | −2.210E−02 | 8.740E−02 | 5.567E−02 | −2.774E−01 |
| G | −7.420E−04 | −1.133E−02 | 1.427E−02 | −5.994E−02 | −3.401E−02 | 2.150E−01 |
| H | 1.678E−04 | 4.790E−03 | −6.526E−03 | 3.001E−02 | 1.504E−02 | −1.200E−01 |
| J | −1.871E−05 | −1.458E−03 | 2.142E−03 | −1.098E−02 | −4.750E−03 | 4.833E−02 |
| L | −1.158E−06 | 3.163E−04 | −5.018E−04 | 2.908E−03 | 1.038E−03 | −1.390E−02 |
| M | 7.700E−07 | −4.771E−05 | 8.193E−05 | −5.434E−04 | −1.471E−04 | 2.779E−03 |
| N | −1.222E−07 | 4.752E−06 | −8.860E−06 | 6.809E−05 | 1.177E−05 | −3.662E−04 |
| O | 9.324E−09 | −2.808E−07 | 5.707E−07 | −5.139E−06 | −3.225E−07 | 2.853E−05 |
| P | −2.916E−10 | 7.456E−09 | −1.659E−08 | 1.769E−07 | −1.035E−08 | −9.919E−07 |

| | S8 | S9 | S10 | S11 | S12 | S13 |
|---|---|---|---|---|---|---|
| K | −6.397E+01 | −2.506E+01 | 4.215E+01 | 1.107E+01 | 9.000E+01 | −5.363E+01 |
| A | −1.604E−02 | −1.447E−02 | −1.406E−02 | −9.694E−03 | −3.913E−03 | −9.137E−02 |
| B | 5.478E−03 | −1.198E−02 | −1.447E−02 | −1.431E−02 | 3.766E−05 | 4.980E−02 |
| C | −4.536E−02 | 2.932E−02 | 2.129E−02 | 1.803E−02 | 2.346E−03 | −1.758E−02 |
| D | 1.408E−01 | −5.411E−02 | −2.273E−02 | −1.914E−02 | −3.396E−03 | 2.755E−03 |
| E | −2.686E−01 | 7.301E−02 | 1.799E−02 | 1.452E−02 | 1.937E−03 | 6.023E−04 |
| F | 3.425E−01 | −7.170E−02 | −9.947E−03 | −7.628E−03 | −6.395E−04 | −4.928E−04 |
| G | −3.056E−01 | 5.086E−02 | 3.765E−03 | 2.814E−03 | 1.294E−04 | 1.488E−04 |
| H | 1.951E−01 | −2.608E−02 | −9.697E−04 | −7.380E−04 | −1.480E−05 | −2.743E−05 |
| J | −8.954E−02 | 9.641E−03 | 1.686E−04 | 1.379E−04 | 5.220E−07 | 3.376E−06 |
| L | 2.933E−02 | −2.540E−03 | −1.934E−05 | −1.819E−05 | 9.513E−08 | −2.838E−07 |
| M | −6.687E−03 | 4.641E−04 | 1.380E−06 | 1.648E−06 | −1.500E−08 | 1.614E−08 |
| N | 1.008E−03 | −5.584E−05 | −5.286E−08 | −9.745E−08 | 9.309E−10 | −5.947E−10 |
| O | −9.042E−05 | 3.974E−06 | 5.811E−10 | 3.380E−09 | −2.673E−11 | 1.283E−11 |
| P | 3.650E−06 | −1.266E−07 | 1.484E−11 | −5.211E−11 | 2.667E−13 | −1.232E−13 |

| | S14 | S15 | S16 | S17 |
|---|---|---|---|---|
| K | −1.020E+00 | −1.156E+00 | −8.915E+01 | −1.109E+00 |
| A | −6.491E−02 | 4.553E−02 | −5.002E−02 | −5.642E−02 |
| B | 2.758E−02 | −2.776E−02 | 1.672E−02 | 1.795E−02 |
| C | −1.424E−02 | 7.836E−03 | −4.747E−03 | −4.976E−03 |
| D | 4.877E−03 | −1.533E−03 | 1.106E−03 | 1.039E−03 |
| E | −1.127E−03 | 2.369E−04 | −1.846E−04 | −1.579E−04 |
| F | 1.807E−04 | −3.222E−05 | 2.149E−05 | 1.733E−05 |
| G | −2.053E−05 | 3.994E−06 | −1.769E−06 | −1.375E−06 |
| H | 1.693E−06 | −4.233E−07 | 1.044E−07 | 7.907E−08 |
| J | −1.032E−07 | 3.504E−08 | −4.445E−09 | −3.285E−09 |
| L | 4.678E−09 | −2.118E−09 | 1.355E−10 | 9.754E−11 |
| M | −1.554E−10 | 8.883E−11 | −2.885E−12 | −2.017E−12 |
| N | 3.596E−12 | −2.431E−12 | 4.079E−14 | 2.757E−14 |
| O | −5.180E−14 | 3.892E−14 | −3.440E−16 | −2.239E−16 |
| P | 3.475E−16 | −2.759E−16 | 1.310E−18 | 8.179E−19 |

In addition, the optical imaging system configured as described above may have aberration properties as illustrated in FIG. 12.

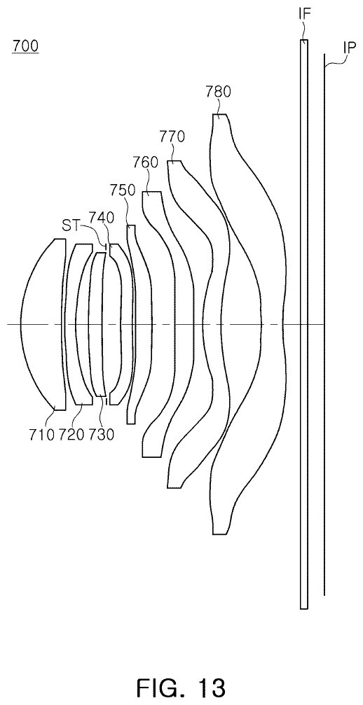

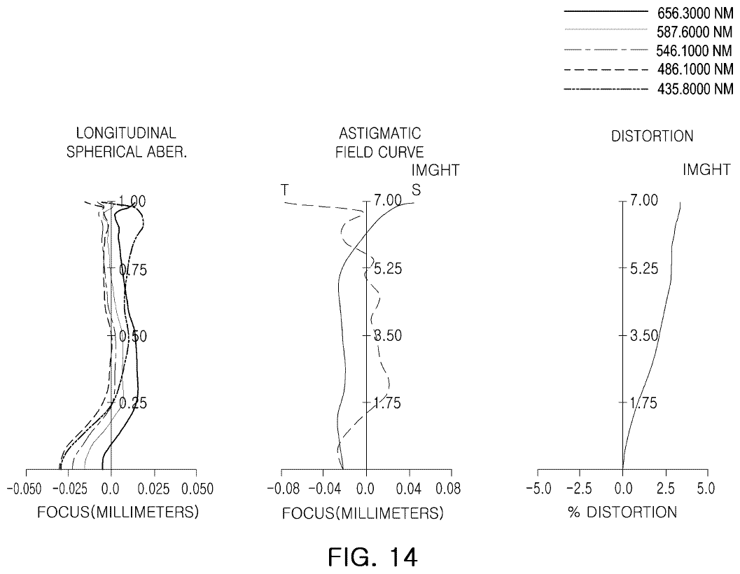

FIG. 13 is a block diagram illustrating an optical imaging system according to a seventh embodiment of the present disclosure, and FIG. 14 is a diagram illustrating aberration properties of the optical imaging system illustrated in FIG. 13.

Referring to FIG. 13, an optical imaging system 700 according to the seventh embodiment of the present disclosure may include a first lens 710, a second lens 720, a third lens 730, a fourth lens 740, a fifth lens 750, a sixth lens 760, a seventh lens 770, and an eighth lens 780 sequentially disposed in ascending numerical order along an optical axis of the optical imaging system 700 from an object side of the optical imaging system 700 toward an imaging plane IP of the optical imaging system 700, and may further include a filter F and an image sensor (not shown) that may include the imaging plane IP.

The optical imaging system 700 may further include a stop ST. The stop ST may be disposed between the third lens 730 and the fourth lens 740. For example, the stop ST may be disposed closer to an image-side surface of the third lens 730 than to an object-side surface of the fourth lens 740.

The optical imaging system 700 according to the seventh embodiment of the present disclosure may form a focal point on the imaging plane IP.

Lens properties (a radius of curvature, a thickness of a lens or a distance between lenses, a refractive index, an Abbe number, and an effective radius) of each lens are listed in Table 13 below.

TABLE 13

| Surface | | Radius of | Thickness/ | Refractive | Abbe | Effective |
|---|---|---|---|---|---|---|
| No. | Element | Curvature | Distance | Index | Number | Radius |
| S1 | First | 3.020 | 1.181 | 1.546 | 55.990 | 2.329 |
| S2 | Lens | 11.187 | 0.084 | | | 2.260 |
| S3 | Second | 8.529 | 0.310 | 1.679 | 19.238 | 2.156 |
| S4 | Lens | 4.897 | 0.349 | | | 1.958 |
| S5 | Third | 8.092 | 0.390 | 1.546 | 55.990 | 1.936 |
| S6 | Lens | 11.941 | 0.167 | | | 1.846 |
| S7 | Stop | Infinity | 0.387 | | | 1.830 |
| S8 | Fourth | 25.829 | 0.310 | 1.695 | 18.408 | 1.881 |
| S9 | Lens | 13.809 | 0.090 | | | 2.168 |
| S10 | Fifth | 29.988 | 0.500 | 1.546 | 55.990 | 2.538 |
| S11 | Lens | −103.222 | 0.648 | | | 2.699 |
| S12 | Sixth | 37.666 | 0.530 | 1.571 | 37.403 | 3.103 |
| S13 | Lens | 10.806 | 0.244 | | | 3.610 |
| S14 | Seventh | 2.402 | 0.530 | 1.546 | 55.990 | 4.145 |
| S15 | Lens | 6.317 | 1.166 | | | 4.435 |
| S16 | Eighth | −7.841 | 0.610 | 1.537 | 55.730 | 5.472 |
| S17 | Lens | 4.750 | 0.534 | | | 5.724 |
| S18 | Filter | Infinity | 0.210 | 1.518 | 64.197 | |
| S19 | | Infinity | 0.441 | | | |
| S20 | Imaging | Infinity | | | | |
| | Plane | | | | | |

In the seventh embodiment of the present disclosure, the first lens 710 may have a positive refractive power. An object-side surface of the first lens 710 may have a convex shape in a paraxial region thereof, and an image-side surface of the first lens 710 may have a concave shape in a paraxial region thereof.

The second lens 720 may have a negative refractive power. An object-side surface of the second lens 720 may have a convex shape in a paraxial region thereof, and an image-side surface of the second lens 720 may have a concave shape in a paraxial region thereof.

The third lens 730 may have a positive refractive power. An object-side surface of the third lens 730 may have a convex shape in a paraxial region thereof, and an image-side surface of the third lens 730 may have a concave shape in a paraxial region thereof.

The fourth lens 740 may have a negative refractive power. An object-side surface of the fourth lens 740 may have a convex shape in a paraxial region thereof, and an image-side surface of the fourth lens 740 may have a concave shape in a paraxial region thereof.

The fifth lens 750 may have a positive refractive power. Both an object-side surface and an image-side surface of the fifth lens 750 may have a convex shape in respective paraxial regions thereof.

The sixth lens 760 may have a negative refractive power. An object-side surface of the sixth lens 760 may have a convex shape in a paraxial region thereof, and an image-side surface of the sixth lens 760 may have a concave shape in a paraxial region thereof.

In addition, either one or both of the object-side surface and the image-side surface of the sixth lens 760 may have at least one inflection point. For example, a paraxial region of the object-side surface of the sixth lens 760 may have a convex shape, and a portion of the object-side surface of the sixth lens 760, other than the paraxial region, may have a concave shape. In addition, a paraxial region of the image-side surface of the sixth lens 760 may have a concave shape, and a portion of the image-side surface of the sixth lens 760, other than the paraxial region, may have a convex shape.

The seventh lens 770 may have a positive refractive power. An object-side surface of the seventh lens 770 may have a convex shape in a paraxial region thereof, and an image-side surface of the seventh lens 770 may have a concave shape in a paraxial region thereof.

In addition, either one or both of the object-side surface and the image-side surface of the seventh lens 770 may have at least one inflection point. For example, a paraxial region of the object-side surface of the seventh lens 770 may have a convex shape, and a portion of the object-side surface of the seventh lens 770, other than the paraxial region, may have a concave shape. In addition, a paraxial region of the image-side surface of the seventh lens 770 may have a concave shape, and a portion of the image-side surface of the seventh lens 770, other than the paraxial region, may have a convex shape.

The eighth lens 780 may have a negative refractive power. Both an object-side surface and an image-side surface of the eighth lens 780 may have a concave shape in respective paraxial regions thereof.

In addition, either one or both of the object-side surface and the image-side surface of the eighth lens 780 may have at least one inflection point. For example, a paraxial region of the object-side surface of the eighth lens 780 may have a concave shape, and a portion of the object-side surface of the eighth lens 780, other than the paraxial region, may have a convex shape. In addition, a paraxial region of the image-side surface of the eighth lens 780 may have a concave shape, and a portion of the image-side surface of the eighth lens 780, other than the paraxial region, may have a convex shape.

Each surface of each of the first to eighth lenses 710 to 780 may have a conic constant K and aspherical surface coefficients A to H, J, and L to P according to Equation 1 discussed above as listed in Table 14 below. Accordingly, the object-side surfaces and the image-side surfaces of the first lens 710 to the eighth lens 780 may all be aspherical surfaces.

TABLE 14

| | S1 | S2 | S3 | S4 | S5 | S6 |
|---|---|---|---|---|---|---|
| K | −1.221E+00 | −1.019E+01 | −1.938E+00 | −7.538E−01 | −1.122E+01 | −2.303E+01 |
| A | 4.103E−03 | −1.154E−02 | −1.788E−02 | −9.658E−03 | −5.745E−03 | −1.027E−03 |
| B | 3.221E−03 | 1.363E−02 | 1.531E−02 | 1.231E−02 | −4.058E−03 | −2.194E−02 |
| C | −4.472E−03 | −2.187E−02 | −9.389E−03 | −1.775E−02 | 2.106E−02 | 6.811E−02 |
| D | 4.804E−03 | 3.332E−02 | 4.661E−03 | 3.196E−02 | −4.994E−02 | −1.354E−01 |
| E | −3.812E−03 | −3.668E−02 | 4.957E−04 | −4.198E−02 | 7.242E−02 | 1.785E−01 |
| F | 2.201E−03 | 2.820E−02 | −4.123E−03 | 3.769E−02 | −6.963E−02 | −1.612E−01 |
| G | −9.115E−04 | −1.543E−02 | 4.409E−03 | −2.341E−02 | 4.620E−02 | 1.013E−01 |
| H | 2.658E−04 | 6.091E−03 | −2.669E−03 | 1.016E−02 | −2.147E−02 | −4.400E−02 |
| J | −5.282E−05 | −1.743E−03 | 1.055E−03 | −3.072E−03 | 6.970E−03 | 1.274E−02 |
| L | 6.641E−06 | 3.579E−04 | −2.824E−04 | 6.305E−04 | −1.546E−03 | −2.197E−03 |
| M | −4.172E−07 | −5.145E−05 | 5.098E−05 | −8.301E−05 | 2.219E−04 | 1.280E−04 |
| N | −5.697E−09 | 4.912E−06 | −5.963E−06 | 6.149E−06 | −1.829E−05 | 2.826E−05 |
| O | 2.618E−09 | −2.798E−07 | 4.090E−07 | −1.671E−07 | 5.968E−07 | −6.215E−06 |
| P | −1.192E−10 | 7.190E−09 | −1.251E−08 | −3.169E−09 | 7.824E−09 | 3.818E−07 |

| | S8 | S9 | S10 | S11 | S12 | S13 |
|---|---|---|---|---|---|---|
| K | −9.000E+01 | −2.349E+01 | 4.600E+01 | 9.000E+01 | −9.000E+01 | −9.000E+01 |
| A | −1.042E−02 | −1.092E−02 | −1.821E−02 | −2.447E−02 | −1.938E−02 | −8.198E−02 |
| B | −6.197E−03 | 1.182E−03 | −5.986E−03 | 1.872E−02 | 7.836E−03 | 3.720E−02 |
| C | −2.910E−03 | −1.486E−02 | 1.284E−02 | −4.549E−02 | 4.513E−04 | −8.828E−03 |
| D | 2.609E−02 | 1.656E−02 | −3.107E−02 | 6.405E−02 | −5.488E−03 | −1.855E−03 |
| E | −7.305E−02 | −3.611E−03 | 4.868E−02 | −5.917E−02 | 4.779E−03 | 2.537E−03 |
| F | 1.197E−01 | −1.062E−02 | −4.683E−02 | 3.777E−02 | −2.387E−03 | −1.136E−03 |
| G | −1.296E−01 | 1.391E−02 | 2.927E−02 | −1.705E−02 | 8.012E−04 | 3.118E−04 |
| H | 9.671E−02 | −9.082E−03 | −1.233E−02 | 5.507E−03 | −1.893E−04 | −5.774E−05 |
| J | −5.056E−02 | 3.806E−03 | 3.566E−03 | −1.275E−03 | 3.200E−05 | 7.403E−06 |
| L | 1.848E−02 | −1.086E−03 | −7.106E−04 | 2.091E−04 | −3.872E−06 | −6.586E−07 |
| M | −4.626E−03 | 2.109E−04 | 9.589E−05 | −2.366E−05 | 3.290E−07 | 3.992E−08 |
| N | 7.562E−04 | −2.672E−05 | −8.379E−06 | 1.751E−06 | −1.867E−08 | −1.573E−09 |
| O | −7.271E−05 | 1.989E−06 | 4.280E−07 | −7.612E−08 | 6.350E−10 | 3.635E−11 |
| P | 3.119E−06 | −6.587E−08 | −9.711E−09 | 1.471E−09 | −9.769E−12 | −3740E−13 |

| | S14 | S15 | S16 | S17 |
|---|---|---|---|---|
| K | −1.022E+00 | −1.010E+00 | −9.000E+01 | −1.105E+00 |
| A | −5.226E−02 | 3.281E−02 | −6.544E−02 | −5.115E−02 |
| B | 1.260E−02 | −2.715E−02 | 2.445E−02 | 1.593E−02 |
| C | −5.453E−03 | 1.023E−02 | −7.974E−03 | −4.369E−03 |
| D | 2.168E−03 | −2.645E−03 | 2.097E−03 | 9.266E−04 |
| E | −6.923E−04 | 4.787E−04 | −3.891E−04 | −1.457E−04 |
| F | 1.612E−04 | −6.082E−05 | 5.004E−05 | 1.674E−05 |
| G | −2.708E−05 | 5.433E−06 | −4.535E−06 | −1.405E−06 |
| H | 3.316E−06 | −3.420E−07 | 2.945E−07 | 8.626E−08 |
| J | −2.958E−07 | 1.546E−08 | −1.378E−08 | −3.863E−09 |
| L | 1.894E−08 | −5.389E−10 | 4.618E−10 | 1.248E−10 |
| M | −8.437E−10 | 1.659E−11 | −1.082E−11 | −2.832E−12 |
| N | 2.476E−11 | −4.641E−13 | 1.684E−13 | 4.284E−14 |
| O | −4.294E−13 | 9.286E−15 | −1.566E−15 | −3.878E−16 |
| P | 3.331E−15 | −8.690E−17 | 6.586E−18 | 1.587E−18 |

In addition, the optical imaging system configured as described above may have aberration properties as illustrated in FIG. 14.

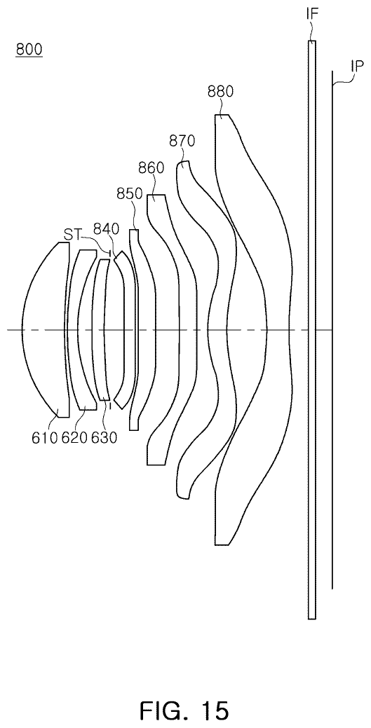

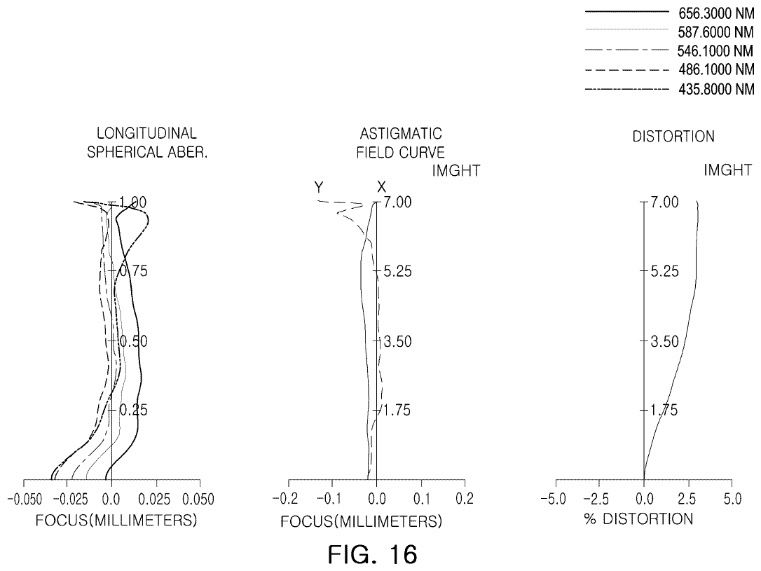

FIG. 15 is a block diagram illustrating an optical imaging system according to an eighth embodiment of the present disclosure, and FIG. 16 is a diagram illustrating aberration properties of the optical imaging system illustrated in FIG. 15.

Referring to FIG. 15, an optical imaging system 800 according to the eighth embodiment of the present disclosure may include a first lens 810, a second lens 820, a third lens 830, a fourth lens 840, a fifth lens 850, a sixth lens 860, a seventh lens 870, and an eighth lens 880 sequentially disposed in ascending numerical order along an optical axis of the optical imaging system 800 from an object side of the optical imaging system 800 toward an imaging plane IP of the optical imaging system 800, and may further include a filter F and an image sensor (not shown) that may include the imaging plane IP.

The optical imaging system 800 may further include a stop ST. The stop ST may be disposed between the third lens 830 and the fourth lens 840. For example, the stop ST may be disposed closer to an image-side surface of the third lens 830 than to an object-side surface of the fourth lens 840.

The optical imaging system 800 according to the eighth embodiment of the present disclosure may form a focal point on the imaging plane IP.

Lens properties (a radius of curvature, a thickness of a lens or a distance between lenses, a refractive index, an Abbe number, and an effective radius) of each lens are listed in Table 15 below.

TABLE 15

| Surface | | Radius of | Thickness/ | Refractive | Abbe | Effective |
|---|---|---|---|---|---|---|
| No. | Element | Curvature | Distance | Index | Number | Radius |
| S1 | First | 3.004 | 1.227 | 1.546 | 55.990 | 2.348 |
| S2 | Lens | 10.970 | 0.059 | | | 2.265 |
| S3 | Second | 7.834 | 0.305 | 1.679 | 19.238 | 2.152 |
| S4 | Lens | 4.730 | 0.375 | | | 1.944 |
| S5 | Third | 7.887 | 0.355 | 1.546 | 55.990 | 1.906 |
| S6 | Lens | 10.644 | 0.190 | | | 1.805 |
| S7 | Stop | Infinity | 0.370 | | | 1.785 |
| S8 | Fourth | 33.989 | 0.305 | 1.695 | 18.408 | 1.872 |
| S9 | Lens | 15.240 | 0.087 | | | 2.159 |
| S10 | Fifth | 24.771 | 0.500 | 1.546 | 55.990 | 2.520 |
| S11 | Lens | −147.394 | 0.636 | | | 2.706 |
| S12 | Sixth | 23.500 | 0.530 | 1.571 | 37.403 | 3.199 |
| S13 | Lens | 12.250 | 0.298 | | | 3.641 |
| S14 | Seventh | 2.552 | 0.530 | 1.546 | 55.990 | 4.334 |
| S15 | Lens | 5.848 | 1.124 | | | 4.537 |
| S16 | Eighth | −9.451 | 0.600 | 1.537 | 55.730 | 5.571 |
| S17 | Lens | 4.614 | 0.534 | | | 5.815 |
| S18 | Filter | Infinity | 0.210 | 1.518 | 64.197 | |
| S19 | | Infinity | 0.444 | | | |
| S20 | Imaging | Infinity | | | | |
| | Plane | | | | | |

In the eighth embodiment of the present disclosure, the first lens 810 may have a positive refractive power. An object-side surface of the first lens 810 may have a convex shape in a paraxial region thereof, and an image-side surface of the first lens 810 may have a concave shape in a paraxial region thereof.

The second lens 820 may have a negative refractive power. An object-side surface of the second lens 820 may have a convex shape in a paraxial region thereof, and an image-side surface of the second lens 820 may have a concave shape in a paraxial region thereof.

The third lens 830 may have a positive refractive power. An object-side surface of the third lens 830 may have a convex shape in a paraxial region thereof, and an image-side surface of the third lens 830 may have a concave shape in a paraxial region thereof.

The fourth lens 840 may have a negative refractive power. An object-side surface of the fourth lens 840 may have a convex shape in a paraxial region thereof, and an image-side surface of the fourth lens 840 may have a concave shape in a paraxial region thereof.

The fifth lens 850 may have a positive refractive power. Both an object-side surface and an image-side surface of the fifth lens 850 may have a convex shape in respective paraxial regions thereof.

The sixth lens 860 may have a negative refractive power. An object-side surface of the sixth lens 860 may have a convex shape in a paraxial region thereof, and an image-side surface of the sixth lens 860 may have a concave shape in a paraxial region thereof.

In addition, either one or both of the object-side surface and the image-side surface of the sixth lens 860 may have at least one inflection point. For example, a paraxial region of the object-side surface of the sixth lens 860 may have a convex shape, and a portion of the object-side surface of the sixth lens 860, other than the paraxial region, may have a concave shape. In addition, a paraxial region of the image-side surface of the sixth lens 860 may have a concave shape, and a portion of the image-side surface of the sixth lens 860, other than the paraxial region, may have a convex shape.

The seventh lens 870 may have a positive refractive power. An object-side surface of the seventh lens 870 may have a convex shape in a paraxial region thereof, and an image-side surface of the seventh lens 870 may have a concave shape in a paraxial region thereof.

In addition, either one or both of the object-side surface and the image-side surface of the seventh lens 870 may have at least one inflection point. For example, a paraxial region of the object-side surface of the seventh lens 870 may have a convex shape, and a portion of the object-side surface of the seventh lens 870, other than the paraxial region, may have a concave shape. In addition, a paraxial region of the image-side surface of the seventh lens 870 may have a concave shape, and a portion of the image-side surface of the seventh lens 870, other than the paraxial region, may have a convex shape.

The eighth lens 880 may have a negative refractive power. Both an object-side surface and an image-side surface of the eighth lens 880 may have a concave shape in respective paraxial regions thereof.

In addition, either one or both of the object-side surface and the image-side surface of the eighth lens 880 may have at least one inflection point. For example, a paraxial region of the object-side surface of the eighth lens 880 may have a concave shape, and a portion of the object-side surface of the eighth lens 880, other than the paraxial region, may have a convex shape. In addition, a paraxial region of the image-side surface of the eighth lens 880 may have a concave shape, and a portion of the image-side surface of the eighth lens 880, other than the paraxial region, may have a convex shape.

Each surface of each of the first to eighth lenses 810 to 880 may have a conic constant K and aspherical surface coefficients A to H, J, and L to P according to Equation 1 discussed above as listed in Table 16 below. Accordingly, the object-side surfaces and the image-side surfaces of the first lens 810 to the eighth lens 880 may all be aspherical surfaces.

TABLE 16

| | S1 | S2 | S3 | S4 | S5 | S6 |
|---|---|---|---|---|---|---|
| K | −1.166E+00 | −9.950E+00 | −1.677E+00 | −4.136E−01 | −7.290E+00 | −1.007E+01 |
| A | 4.604E−03 | −1.478E−02 | −2.014E−02 | −5.895E−03 | −7.515E−03 | −3.172E−03 |
| B | 2.126E−03 | 7.619E−03 | 1.197E−02 | −8.196E−03 | 5.330E−03 | −1.688E−02 |
| C | −4.364E−03 | 1.284E−02 | 1.583E−02 | 5.631E−02 | −1.221E−02 | 7.016E−02 |
| D | 6.787E−03 | −3.285E−02 | −4.656E−02 | −1.278E−01 | 2.340E−02 | −1.821E−01 |
| E | −7.072E−03 | 3.884E−02 | 6.229E−02 | 1.844E−01 | −3.279E−02 | 3.149E−01 |
| F | 5.036E−03 | −3.001E−02 | −5.499E−02 | −1.846E−01 | 3.395E−02 | −3.783E−01 |
| G | −2.511E−03 | 1.629E−02 | 3.436E−02 | 1.326E−01 | −2.595E−02 | 3.243E−01 |
| H | 8.904E−04 | −6.366E−03 | −1.550E−02 | −6.917E−02 | 1.465E−02 | −2.009E−01 |
| J | −2.255E−04 | 1.799E−03 | 5.069E−03 | 2.627E−02 | −6.063E−03 | 9.009E−02 |
| L | 4.045E−05 | −3.644E−04 | −1.188E−03 | −7.188E−03 | 1.811E−03 | −2.897E−02 |
| M | −5.012E−06 | 5.155E−05 | 1.944E−04 | 1.380E−03 | −3.787E−04 | 6.505E−03 |
| N | 4.072E−07 | −4.836E−06 | −2.109E−05 | −1.765E−04 | 5.248E−05 | −9.684E−04 |
| O | −1.947E−08 | 2.703E−07 | 1.362E−06 | 1.349E−05 | −4.319E−06 | 8.583E−05 |
| P | 4.143E−10 | −6.810E−09 | −3.965E−08 | −4.664E−07 | 1.596E−07 | −3.426E−06 |

| | S8 | S9 | S10 | S11 | S12 | S13 |
|---|---|---|---|---|---|---|
| K | 8.990E+01 | −1.614E+01 | −6.334E+00 | −7.609E+00 | −7.027E+01 | −6.110E+01 |
| A | −1.056E−02 | −1.795E−02 | −2.782E−02 | −2.543E−02 | −2.863E−02 | −8.379E−02 |
| B | −9.287E−03 | 1.589E−02 | 1.609E−02 | 1.428E−02 | 1.711E−02 | 4.235E−02 |
| C | 2.649E−02 | −3.063E−02 | −1.809E−02 | −2.570E−02 | −6.250E−03 | −1.305E−02 |
| D | −7.737E−02 | 2.066E−02 | 2.365E−03 | 3.172E−02 | −1.635E−03 | 1.897E−04 |
| E | 1.384E−01 | 8.605E−03 | 1.820E−02 | −2.789E−02 | 2.917E−03 | 1.868E−03 |
| F | −1.630E−01 | −3.086E−02 | −2.450E−02 | 1.763E−02 | −1.614E−03 | −9.764E−04 |
| G | 1.317E−01 | 3.122E−02 | 1.716E−02 | −8.001E−03 | 5.332E−04 | 2.818E−04 |
| H | −7.476E−02 | −1.884E−02 | −7.674E−03 | 2.615E−03 | −1.163E−04 | −5.304E−05 |
| J | 2.997E−02 | 7.628E−03 | 2.317E−03 | −6.138E−04 | 1.724E−05 | 6.805E−06 |
| L | −8.389E−03 | −2.134E−03 | −4.789E−04 | 1.022E−04 | −1.741E−06 | −6.006E−07 |
| M | 1.590E−03 | 4.087E−04 | 6.689E−05 | −1.171E−05 | 1.175E−07 | 3.594E−08 |
| N | −1.912E−04 | −5.127E−05 | −6.040E−06 | 8.771E−07 | −5.052E−09 | −1.395E−09 |
| O | 1.280E−05 | 3.795E−06 | 3.185E−07 | −3.848E−08 | 1.247E−10 | 3.170E−11 |
| P | −3.408E−07 | −1.256E−07 | −7.451E−09 | 7.486E−10 | −1.339E−12 | −3.203E−13 |

| | S14 | S15 | S16 | S17 |
|---|---|---|---|---|
| K | −9.749E−01 | −1.178E+00 | −7.581E+01 | −1.248E+00 |
| A | −5.060E−02 | 2.394E−02 | −5.140E−02 | −4.702E−02 |
| B | 1.250E−02 | −2.243E−02 | 1.498E−02 | 1.317E−02 |
| C | −4.784E−03 | 9.536E−03 | −3.744E−03 | −3.299E−03 |
| D | 1.669E−03 | −2.983E−03 | 8.481E−04 | 6.556E−04 |
| E | −5.269E−04 | 6.846E−04 | −1.482E−04 | −9.917E−05 |
| F | 1.303E−04 | −1.158E−04 | 1.867E−05 | 1.114E−05 |
| G | −2.337E−05 | 1.462E−05 | −1.684E−06 | −9.183E−07 |
| H | 2.987E−06 | −1.389E−06 | 1.096E−07 | 5.514E−08 |
| J | −2.709E−07 | 9.946E−08 | −5.162E−09 | −2.399E−09 |
| L | 1.723E−08 | −5.290E−09 | 1.743E−10 | 7.462E−11 |
| M | −7.499E−10 | 2.025E−10 | −4.115E−12 | −1.616E−12 |
| N | 2.124E−11 | −5.253E−12 | 6.451E−14 | 2.313E−14 |
| O | −3.527E−13 | 8.234E−14 | −6.031E−16 | −1.965E−16 |
| P | 2.603E−15 | −5.859E−16 | 2.544E−18 | 7.496E−19 |

In addition, the optical imaging system configured as described above may have aberration properties as illustrated in FIG. 16.

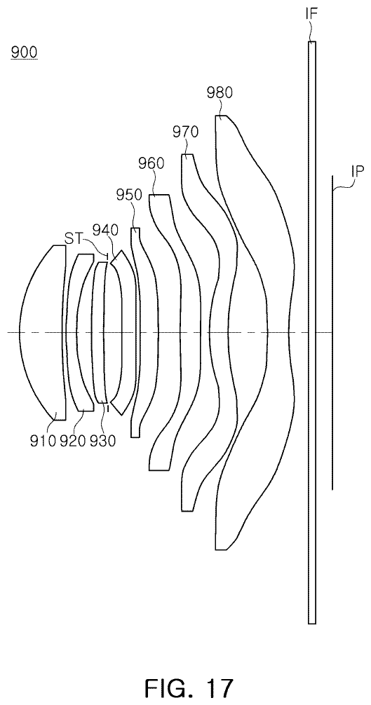

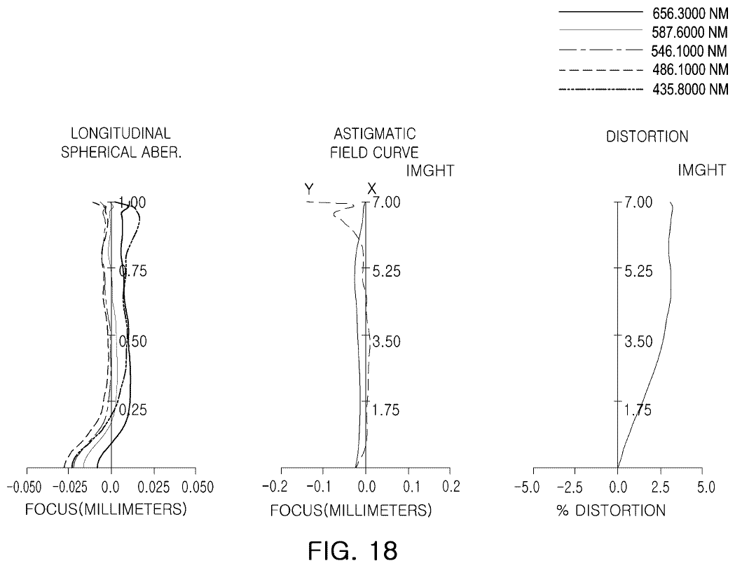

FIG. 17 is a block diagram illustrating an optical imaging system according to a ninth embodiment of the present disclosure, and FIG. 18 is a diagram illustrating aberration properties of the optical imaging system illustrated in FIG. 17.

Referring to FIG. 17, an optical imaging system 900 according to the ninth embodiment of the present disclosure may include a first lens 910, a second lens 920, a third lens 930, a fourth lens 940, a fifth lens 950, a sixth lens 960, a seventh lens 970, and an eighth lens 980 sequentially disposed in ascending numerical order along an optical axis of the optical imaging system 900 from an object side of the optical imaging system 900 toward an imaging plane IP of the optical imaging system 900, and may further include a filter F and an image sensor (not shown) that may include the imaging plane IP.

The optical imaging system 900 may further include a stop ST. The stop ST may be disposed between the third lens 930 and the fourth lens 940. For example, the stop ST may be disposed closer to an image-side surface of the third lens 930 than to an object-side surface of the fourth lens 940.

The optical imaging system 900 according to the ninth embodiment of the present disclosure may form a focal point on the imaging plane IP.

Lens properties (a radius of curvature, a thickness of a lens or a distance between lenses, a refractive index, an Abbe number, and an effective radius) of each lens are listed in Table 17 below.

TABLE 17

| Surface | | Radius of | Thickness/ | Refractive | Abbe | Effective |
|---|---|---|---|---|---|---|
| No. | Element | Curvature | Distance | Index | Number | Radius |
| S1 | First | 3.104 | 1.240 | 1.546 | 55.990 | 2.358 |
| S2 | Lens | 13.624 | 0.101 | | | 2.268 |
| S3 | Second | 7.193 | 0.305 | 1.679 | 19.238 | 2.119 |
| S4 | Lens | 4.376 | 0.411 | | | 1.913 |
| S5 | Third | 9.633 | 0.350 | 1.546 | 55.990 | 1.895 |
| S6 | Lens | 13.453 | 0.146 | | | 1.826 |
| S7 | Stop | Infinity | 0.378 | | | 1.815 |
| S8 | Fourth | 83.893 | 0.391 | 1.695 | 18.408 | 1.875 |
| S9 | Lens | 18.177 | 0.096 | | | 2.234 |
| S10 | Fifth | 24.519 | 0.543 | 1.546 | 55.990 | 2.673 |
| S11 | Lens | −134.707 | 0.625 | | | 2.839 |
| S12 | Sixth | 23.020 | 0.560 | 1.571 | 37.403 | 3.316 |
| S13 | Lens | 12.231 | 0.245 | | | 3.726 |
| S14 | Seventh | 2.657 | 0.530 | 1.546 | 55.990 | 4.594 |
| S15 | Lens | 7.437 | 1.106 | | | 4.812 |
| S16 | Eighth | −24.252 | 0.600 | 1.537 | 55.730 | 5.674 |
| S17 | Lens | 3.536 | 0.534 | | | 5.875 |
| S18 | Filter | Infinity | 0.210 | 1.518 | 64.197 | |
| S19 | | Infinity | 0.509 | | | |
| S20 | Imaging | Infinity | | | | |
| | Plane | | | | | |

In the ninth embodiment of the present disclosure, the first lens 910 may have a positive refractive power. An object-side surface of the first lens 910 may have a convex shape in a paraxial region thereof, and an image-side surface of the first lens 910 may have a concave shape in a paraxial region thereof.

The second lens 920 may have a negative refractive power. An object-side surface of the second lens 920 may have a convex shape in a paraxial region thereof, and an image-side surface of the second lens 920 may have a concave shape in a paraxial region thereof.

The third lens 930 may have a positive refractive power. An object-side surface of the third lens 930 may have a convex shape in a paraxial region thereof, and an image-side surface of the third lens 930 may have a concave shape in a paraxial region thereof.

The fourth lens 940 may have a negative refractive power. An object-side surface of the fourth lens 940 may have a convex shape in a paraxial region thereof, and an image-side surface of the fourth lens 940 may have a concave shape in a paraxial region thereof.

The fifth lens 950 may have a positive refractive power. Both an object-side surface and an image-side surface of the fifth lens 950 may have a convex shape in respective paraxial regions thereof.

The sixth lens 960 may have a negative refractive power. An object-side surface of the sixth lens 960 may have a convex shape in a paraxial region thereof, and an image-side surface of the sixth lens 960 may have a concave shape in a paraxial region thereof.

In addition, either one or both of the object-side surface and the image-side surface of the sixth lens 960 may have at least one inflection point. For example, a paraxial region of the object-side surface of the sixth lens 960 may have a convex shape, and a portion of the object-side surface of the sixth lens 960, other than the paraxial region, may have a concave shape. In addition, a paraxial region of the image-side surface of the sixth lens 960 may have a concave shape, and a portion of the image-side surface of the sixth lens 960, other than the paraxial region, may have a convex shape.

The seventh lens 970 may have a positive refractive power. An object-side surface of the seventh lens 970 may have a convex shape in a paraxial region thereof, and an image-side surface of the seventh lens 970 may have a concave shape in a paraxial region thereof.

In addition, either one or both of the object-side surface and the image-side surface of the seventh lens 970 may have at least one inflection point. For example, a paraxial region of the object-side surface of the seventh lens 970 may have a convex shape, and a portion of the object-side surface of the seventh lens 970, other than the paraxial region, may have a concave shape. In addition, a paraxial region of the image-side surface of the seventh lens 970 may have a concave shape, and a portion of the image-side surface of the seventh lens 970, other than the paraxial region, may have a convex shape.

The eighth lens 980 may have a negative refractive power. Both an object-side surface and an image-side surface of the eighth lens 980 may have a concave shape in respective paraxial regions thereof.

In addition, either one or both of the object-side surface and the image-side surface of the eighth lens 980 may have at least one inflection point. For example, a paraxial region of the object-side surface of the eighth lens 980 may have a concave shape, and a portion of the object-side surface of the eighth lens 980, other than the paraxial region, may have a convex shape. In addition, a paraxial region of the image-side surface of the eighth lens 980 may have a concave shape, and a portion of the image-side surface of the eighth lens 980, other than the paraxial region, may have a convex shape.

Each surface of each of the first to eighth lenses 910 to 980 may have a conic constant K and aspherical surface coefficients A to H, J, and L to P according to Equation 1 discussed above as listed in Table 18 below. Accordingly, the object-side surfaces and the image-side surfaces of the first lens 910 to the eighth lens 980 may all be aspherical surfaces.

TABLE 18

| | S1 | S2 | S3 | S4 | S5 | S6 |
|---|---|---|---|---|---|---|
| K | −1.226E+00 | −5.844E+00 | −2.337E+00 | −8.224E−01 | −8.297E+00 | −2.254E+01 |
| A | 4.811E−03 | −1.159E−02 | −1.913E−02 | −9.291E−03 | −6.796E−03 | −4.452E−03 |
| B | 1.188E−03 | 9.838E−03 | 1.595E−02 | 1.817E−03 | 4.767E−03 | −4.017E−03 |
| C | −3.569E−03 | −5.234E−03 | −7.514E−03 | 2.687E−02 | −1.496E−02 | 7.615E−03 |
| D | 6.784E−03 | 1.989E−03 | 3.533E−03 | −7.201E−02 | 4.174E−02 | 1.716E−03 |
| E | −7.900E−03 | −9.215E−04 | −3.240E−03 | 1.161E−01 | −7.871E−02 | −3.396E−02 |
| F | 6.054E−03 | 7.090E−04 | 3.367E−03 | −1.290E−01 | 1.016E−01 | 7.190E−02 |
| G | −3.195E−03 | −5.002E−04 | −2.461E−03 | 1.021E−01 | −9.160E−02 | −8.408E−02 |
| H | 1.189E−03 | 2.464E−04 | 1.221E−03 | −5.828E−02 | 5.869E−02 | 6.406E−02 |
| J | −3.154E−04 | −8.291E−05 | −4.200E−04 | 2.399E−02 | −2.686E−02 | −3.347E−02 |
| L | 5.922E−05 | 1.915E−05 | 1.007E−04 | −7.047E−03 | 8.718E−03 | 1.214E−02 |
| M | −7.695E−06 | −2.995E−06 | −1.658E−05 | 1.438E−03 | −1.959E−03 | −3.010E−03 |
| N | 6.582E−07 | 3.038E−07 | 1.793E−06 | −1.933E−04 | 2.900E−04 | 4.878E−04 |
| O | −3.333E−08 | −1.805E−08 | −1.149E−07 | 1.539E−05 | −2.543E−05 | −4.658E−05 |
| P | 7.565E−10 | 4.771E−10 | 3.312E−09 | −5.483E−07 | 1.000E−06 | 1.989E−06 |

| | S8 | S9 | S10 | S11 | S12 | S13 |
|---|---|---|---|---|---|---|
| K | 9.000E+01 | 2.598E+00 | −3.304E+00 | 9.000E+01 | −3.473E+01 | −5.493E+01 |
| A | −1.625E−02 | −2.371E−02 | −3.312E−02 | −2.331E−02 | −2.244E−02 | −7.490E−02 |
| B | 1.459E−02 | 2.979E−02 | 4.088E−02 | 1.076E−02 | 1.365E−02 | 3.199E−02 |
| C | −5.026E−02 | −6.098E−02 | −7.488E−02 | −1.616E−02 | −6.675E−03 | −7.124E−03 |
| D | 9.338E−02 | 7.251E−02 | 8.809E−02 | 1.647E−02 | 1.256E−03 | −1.416E−03 |
| E | −1.220E−01 | −5.477E−02 | −6.935E−02 | −1.220E−02 | 2.983E−04 | 1.807E−03 |
| F | 1.176E−01 | 2.525E−02 | 3.769E−02 | 6.692E−03 | −2.862E−04 | −7.565E−04 |
| G | −8.631E−02 | −5.438E−03 | −1.431E−02 | −2.699E−03 | 9.660E−05 | 1.940E−04 |
| H | 4.881E−02 | −1.000E−03 | 3.818E−03 | 7.967E−04 | −1.884E−05 | −3.348E−05 |
| J | −2.111E−02 | 1.180E−03 | −7.133E−04 | −1.710E−04 | 2.242E−06 | 3.998E−06 |
| L | 6.828E−03 | −4.319E−04 | 9.185E−05 | 2.621E−05 | −1.541E−07 | −3.311E−07 |
| M | −1.589E−03 | 9.112E−05 | −7.853E−06 | −2.778E−06 | 4.469E−09 | 1.868E−08 |
| N | 2.499E−04 | −1.173E−05 | 4.128E−07 | 1.925E−07 | 1.124E−10 | −6.852E−10 |
| O | −2.368E−05 | 8.595E−07 | −1.129E−08 | −7.808E−09 | −1.181E−11 | 1.475E−11 |
| P | 1.018E−06 | −2.759E−08 | 9.865E−11 | 1.402E−10 | 2.460E−13 | −1.414E−13 |

| | S14 | S15 | S16 | S17 |
|---|---|---|---|---|
| K | −9.649E−01 | −1.353E−01 | −6.014E+01 | −1.491E+00 |
| A | −3.609E−02 | 3.787E−02 | −4.731E−02 | −5.280E−02 |
| B | 5.454E−03 | −2.474E−02 | 1.118E−02 | 1.426E−02 |
| C | −1.916E−03 | 7.952E−03 | −2.346E−03 | −3.427E−03 |
| D | 5.039E−04 | −1.840E−03 | 5.344E−04 | 6.664E−04 |
| E | −1.056E−04 | 3.099E−04 | −9.750E−05 | −9.903E−05 |
| F | 1.716E−05 | −3.740E−05 | 1.244E−05 | 1.092E−05 |
| G | −2.059E−06 | 3.140E−06 | −1.105E−06 | −8.843E−07 |
| H | 1.851E−07 | −1.727E−07 | 6.968E−08 | 5.230E−08 |
| J | −1.279E−08 | 5.138E−09 | −3.144E−09 | −2.247E−09 |
| L | 6.755E−10 | 1.090E−11 | 1.011E−10 | 6.920E−11 |
| M | −2.612E−11 | −7.596E−12 | −2.268E−12 | −1.487E−12 |
| N | 6.851E−13 | 3.018E−13 | 3.369E−14 | 2.114E−14 |
| O | −1.073E−14 | −5.414E−15 | −2.983E−16 | −1.786E−16 |
| P | 7.520E−17 | 3.886E−17 | 1.191E−18 | 6.785E−19 |

In addition, the optical imaging system configured as described above may have aberration properties as illustrated in FIG. 18.

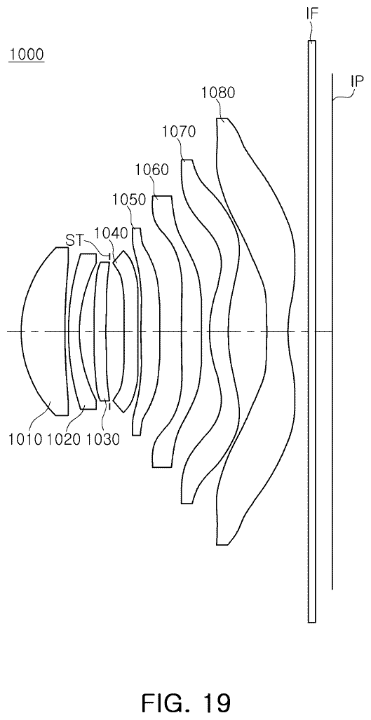

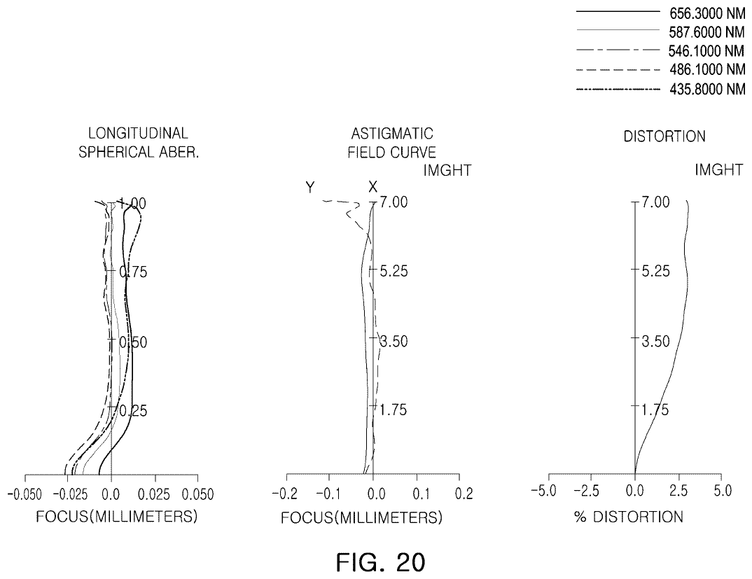

FIG. 19 is a block diagram illustrating an optical imaging system according to a tenth embodiment of the present disclosure, and FIG. 20 is a diagram illustrating aberration properties of the optical imaging system illustrated in FIG. 19.

Referring to FIG. 19, an optical imaging system 1000 according to the tenth embodiment of the present disclosure may include a first lens 1010, a second lens 1020, a third lens 1030, a fourth lens 1040, a fifth lens 1050, a sixth lens 1060, a seventh lens 1070, and an eighth lens 1080 sequentially disposed in ascending numerical order along an optical axis of the optical imaging system 1000 from an object side of the optical imaging system 1000 toward an imaging plane IP of the optical imaging system 1000, and may further include a filter F and an image sensor (not shown) that may include the imaging plane IP.

The optical imaging system 1000 may further include a stop ST. The stop ST may be disposed between the third lens 1030 and the fourth lens 1040. For example, the stop ST may be disposed closer to an image-side surface of the third lens 1030 than to an object-side surface of the fourth lens 1040.

The optical imaging system 1000 according to the tenth embodiment of the present disclosure may form a focal point on the imaging plane P.

Lens properties (a radius of curvature, a thickness of a lens or a distance between lenses, a refractive index, an Abbe number, and an effective radius) of each lens are listed in Table 19 below.

TABLE 19

| Surface | | Radius of | Thickness/ | Refractive | Abbe | Effective |
|---|---|---|---|---|---|---|
| No. | Element | Curvature | Distance | Index | Number | Radius |
| S1 | First | 3.108 | 1.237 | 1.546 | 55.990 | 2.358 |
| S2 | Lens | 13.220 | 0.112 | | | 2.267 |
| S3 | Second | 7.192 | 0.305 | 1.679 | 19.238 | 2.116 |
| S4 | Lens | 4.382 | 0.406 | | | 1.911 |
| S5 | Third | 9.362 | 0.350 | 1.546 | 55.990 | 1.894 |
| S6 | Lens | 13.454 | 0.147 | | | 1.833 |
| S7 | Stop | Infinity | 0.377 | | | 1.820 |
| S8 | Fourth | 96.027 | 0.388 | 1.695 | 18.408 | 1.877 |
| S9 | Lens | 18.779 | 0.095 | | | 2.231 |
| S10 | Fifth | 22.784 | 0.531 | 1.546 | 55.990 | 2.652 |
| S11 | Lens | −494.348 | 0.629 | | | 2.816 |
| S12 | Sixth | 22.241 | 0.563 | 1.571 | 37.403 | 3.311 |
| S13 | Lens | 12.076 | 0.245 | | | 3.713 |
| S14 | Seventh | 2.692 | 0.530 | 1.546 | 55.990 | 4.450 |
| S15 | Lens | 7.770 | 1.108 | | | 4.718 |
| S16 | Eighth | −31.430 | 0.600 | 1.537 | 55.730 | 5.624 |
| S17 | Lens | 3.430 | 0.534 | | | 5.836 |
| S18 | Filter | Infinity | 0.210 | 1.518 | 64.197 | |
| S19 | | Infinity | 0.515 | | | |
| S20 | Imaging | Infinity | | | | |
| | Plane | | | | | |

In the tenth embodiment of the present disclosure, the first lens 1010 may have a positive refractive power. An object-side surface of the first lens 1010 may have a convex shape in a paraxial region thereof, and an image-side surface of the first lens 1010 may have a concave shape in a paraxial region thereof.

The second lens 1020 may have a negative refractive power. An object-side surface of the second lens 1020 may have a convex shape in a paraxial region thereof, and an image-side surface of the second lens 1020 may have a concave shape in a paraxial region thereof.

The third lens 1030 may have a positive refractive power. An object-side surface of the third lens 1030 may have a convex shape in a paraxial region thereof, and an image-side surface of the third lens 1030 may have a concave shape in a paraxial region thereof.

The fourth lens 1040 may have a negative refractive power. An object-side surface of the fourth lens 1040 may have a convex shape in a paraxial region thereof, and an image-side surface of the fourth lens 1040 may have a concave shape in a paraxial region thereof.

The fifth lens 1050 may have a positive refractive power. Both an object-side surface and an image-side surface of the fifth lens 1050 may have a convex shape in respective paraxial regions thereof.

The sixth lens 1060 may have a negative refractive power. An object-side surface of the sixth lens 1060 may have a convex shape in a paraxial region thereof, and an image-side surface of the sixth lens 1060 may have a concave shape in a paraxial region thereof.

In addition, either one or both of the object-side surface and the image-side surface of the sixth lens 1060 may have at least one inflection point. For example, a paraxial region of the object-side surface of the sixth lens 1060 may have a convex shape, and a portion of the object-side surface of the sixth lens 1060, other than the paraxial region, may have a concave shape. In addition, a paraxial region of the image-side surface of the sixth lens 1060 may have a concave shape, and a portion of the image-side surface of the sixth lens 1060, other than the paraxial region, may have a convex shape.

The seventh lens 1070 may have a positive refractive power. An object-side surface of the seventh lens 1070 may have a convex shape in a paraxial region thereof, and an image-side surface of the seventh lens 1070 may have a concave shape in a paraxial region thereof.

In addition, either one or both of the object-side surface and the image-side surface of the seventh lens 1070 may have at least one inflection point. For example, a paraxial region of the object-side surface of the seventh lens 1070 may have a convex shape, and a portion of the object-side surface of the seventh lens 1070, other than the paraxial region, may have a concave shape. In addition, a paraxial region of the image-side surface of the seventh lens 1070 may have a concave shape, and a portion of the image-side surface of the seventh lens 1070, other than the paraxial region, may have a convex shape.

The eighth lens 1080 may have a negative refractive power. Both an object-side surface and an image-side surface of the eighth lens 1080 may have a concave shape in respective paraxial regions thereof.

In addition, either one or both of the object-side surface and the image-side surface of the eighth lens 1080 may have at least one inflection point. For example, a paraxial region of the object-side surface of the eighth lens 1080 may have a concave shape, and a portion of the object-side surface of the eighth lens 1080, other than the paraxial region, may have a convex shape. In addition, a paraxial region of the image-side surface of the eighth lens 1080 may have a concave shape, and a portion of the image-side surface of the eighth lens 1080, other than the paraxial region, may have a convex shape.

Each surface of each of the first to eighth lenses 1010 to 1080 may have a conic constant K and aspherical surface coefficients A to H, J, and L to P according to Equation 1 discussed above as listed in Table 20 below. Accordingly, the object-side surfaces and the image-side surfaces of the first lens 1010 to the eighth lens 1080 may all be aspherical surfaces.

TABLE 20

| | S1 | S2 | S3 | S4 | S5 | S6 |
|---|---|---|---|---|---|---|
| K | −1.230E+00 | −6.077E+00 | −2.390E+00 | −8.288E−01 | −8.623E+00 | −2.586E+01 |
| A | 5.155E−03 | −1.077E−02 | −1.892E−02 | −9.664E−03 | −7.073E−03 | −4.268E−03 |
| B | −3.167E−04 | 7.933E−03 | 1.504E−02 | 1.379E−03 | 5.955E−03 | −5.096E−03 |
| C | −1.360E−04 | −2.553E−03 | −6.102E−03 | 3.019E−02 | −1.832E−02 | 1.124E−02 |
| D | 1.905E−03 | −8.045E−04 | 2.123E−03 | −8.071E−02 | 4.842E−02 | −6.274E−03 |
| E | −3.277E−03 | 1.227E−03 | −2.190E−03 | 1.308E−01 | −8.758E−02 | −2.187E−02 |
| F | 3.007E−03 | −4.864E−04 | 2.774E−03 | −1.460E−01 | 1.094E−01 | 5.895E−02 |
| G | −1.761E−03 | −2.694E−05 | −2.213E−03 | 1.160E−01 | −9.617E−02 | −7.411E−02 |
| H | 7.016E−04 | 1.161E−04 | 1.150E−03 | −6.644E−02 | 6.033E−02 | 5.848E−02 |
| J | −1.950E−04 | −5.922E−05 | −4.070E−04 | 2.744E−02 | −2.712E−02 | −3.119E−02 |
| L | 3.791E−05 | 1.669E−05 | 9.979E−05 | −8.089E−03 | 8.665E−03 | 1.146E−02 |
| M | −5.057E−06 | −2.945E−06 | −1.674E−05 | 1.657E−03 | −1.921E−03 | −2.867E−03 |
| N | 4.414E−07 | 3.246E−07 | 1.841E−06 | −2.239E−04 | 2.808E−04 | 4.673E−04 |
| O | −2.271E−08 | −2.053E−08 | −1.197E−07 | 1.792E−05 | −2.435E−05 | −4.480E−05 |
| P | 5.220E−10 | 5.705E−10 | 3.500E−09 | −6.430E−07 | 9.480E−07 | 1.918E−06 |

| | S8 | S9 | S10 | S11 | S12 | S13 |
|---|---|---|---|---|---|---|
| K | 9.000E+01 | 5.071E+00 | −2.528E+01 | 9.000E+01 | −2.489E+01 | −5.353E+01 |
| A | −1.603E−02 | −2.219E−02 | −3.128E−02 | −2.367E−02 | −2.244E−02 | −7.147E−02 |
| B | 1.412E−02 | 2.196E−02 | 3.227E−02 | 1.267E−02 | 1.466E−02 | 2.810E−02 |
| C | −5.008E−02 | −4.047E−02 | −5.579E−02 | −2.110E−02 | −9.013E−03 | −5.009E−03 |
| D | 9.760E−02 | 3.945E−02 | 6.202E−02 | 2.353E−02 | 3.781E−03 | −2.073E−03 |
| E | −1.356E−01 | −1.883E−02 | −4.570E−02 | −1.853E−02 | −1.316E−03 | 1.921E−03 |
| F | 1.396E−01 | −2.295E−03 | 2.289E−02 | 1.050E−02 | 3.998E−04 | −7.594E−04 |
| G | −1.088E−01 | 9.833E−03 | −7.781E−03 | −4.297E−03 | −1.070E−04 | 1.899E−04 |
| H | 6.436E−02 | −7.209E−03 | 1.759E−03 | 1.273E−03 | 2.414E−05 | −3.234E−05 |
| J | −2.861E−02 | 3.034E−03 | −2.481E−04 | −2.718E−04 | −4.226E−06 | 3.829E−06 |
| L | 9.355E−03 | −8.338E−04 | 1.710E−05 | 4.127E−05 | 5.333E−07 | −3.154E−07 |
| M | −2.173E−03 | 1.526E−04 | 4.955E−07 | −4.326E−06 | −4.582E−08 | 1.774E−08 |
| N | 3.383E−04 | −1.802E−05 | −2.033E−07 | 2.964E−07 | 2.518E−09 | −6.502E−10 |
| O | −3.155E−05 | 1.245E−06 | 1.575E−08 | −1.190E−08 | −7.951E−11 | 1.400E−11 |
| P | 1.331E−06 | −3.826E−08 | −4.363E−10 | 2.120E−10 | 1.095E−12 | −1.345E−13 |

| | S14 | S15 | S16 | S17 |
|---|---|---|---|---|
| K | −9.651E−01 | −9.989E−02 | −3.385E+01 | −1.533E+00 |
| A | −3.121E−02 | 4.016E−02 | −4.868E−02 | −5.455E−02 |
| B | 2.764E−03 | −2.428E−02 | 1.185E−02 | 1.506E−02 |
| C | −8.401E−04 | 7.178E−03 | −2.531E−03 | −3.661E−03 |
| D | 1.527E−04 | −1.475E−03 | 5.804E−04 | 7.146E−04 |
| E | −1.275E−05 | 2.080E−04 | −1.070E−04 | −1.059E−04 |
| F | −1.994E−06 | −1.815E−05 | 1.383E−05 | 1.157E−05 |
| G | 8.936E−07 | 5.835E−07 | −1.245E−06 | −9.226E−07 |
| H | −1.458E−07 | 6.988E−08 | 7.927E−08 | 5.349E−08 |
| J | 1.378E−08 | −1.129E−08 | −3.608E−09 | −2.244E−09 |
| L | −8.301E−10 | 7.942E−10 | 1.168E−10 | 6.727E−11 |
| M | 3.266E−11 | −3.318E−11 | −2.632E−12 | −1.402E−12 |
| N | −8.199E−13 | 8.439E−13 | 3.923E−14 | 1.929E−14 |
| O | 1.204E−14 | −1.210E−14 | −3.480E−16 | −1.571E−16 |
| P | −7.952E−17 | 7.501E−17 | 1.390E−18 | 5.735E−19 |

In addition, the optical imaging system configured as described above may have aberration properties as illustrated in FIG. 20.

Table 21 below lists optical and physical properties of the optical imaging systems according to the first to tenth embodiments of the present disclosure.

TABLE 21

| Property | Emb. 1 | Emb. 2 | Emb. 3 | Emb. 4 | Emb. 5 |
|---|---|---|---|---|---|
| TTL | 8.670 | 8.670 | 8.670 | 8.681 | 8.681 |
| BFL | 1.026 | 1.071 | 1.081 | 1.226 | 1.229 |
| Fno | 1.574 | 1.574 | 1.573 | 1.573 | 1.573 |
| IMG HT | 7.000 | 7.000 | 7.000 | 7.000 | 7.000 |
| FOV | 85.3 | 85.3 | 85.3 | 85.3 | 85.3 |
| f | 7.429 | 7.428 | 7.428 | 7.328 | 7.328 |
| f1 | 6.765 | 6.656 | 6.831 | 7.370 | 7.426 |
| f2 | −16.310 | −14.886 | −15.132 | −18.496 | −18.647 |
| f3 | 67.406 | 48.654 | 54.033 | 42.743 | 44.400 |
| f4 | −37.199 | −62.867 | −54.579 | −66.007 | −64.670 |
| f5 | 29.591 | 62.031 | 45.978 | 44.925 | 45.697 |
| f6 | −89.854 | −42.712 | −33.901 | −18.163 | −19.982 |
| f7 | 8.961 | 7.907 | 7.431 | 6.721 | 6.808 |
| f8 | −5.107 | −5.245 | −5.387 | −5.998 | −5.983 |
| R1 | 3.047 | 3.052 | 3.089 | 2.946 | 2.949 |
| R2 | 14.857 | 16.279 | 15.499 | 9.410 | 9.254 |
| T1 | 1.243 | 1.239 | 1.194 | 1.195 | 1.190 |
| d45 | 0.091 | 0.050 | 0.101 | 0.210 | 0.210 |
| v1 | 55.990 | 55.990 | 55.990 | 55.990 | 55.990 |
| v2 | 18.408 | 18.408 | 19.238 | 19.238 | 19.238 |
| v4 | 18.408 | 18.408 | 19.238 | 18.408 | 18.408 |
| Property | Emb. 6 | Emb. 7 | Emb. 8 | Emb. 9 | Emb. 10 |
| TTL | 8.680 | 8.681 | 8.679 | 8.880 | 8.882 |
| BFL | 1.224 | 1.185 | 1.188 | 1.253 | 1.259 |
| Fno | 1.573 | 1.573 | 1.574 | 1.574 | 1.574 |
| IMG HT | 7.000 | 7.000 | 7.000 | 7.000 | 7.000 |
| FOV | 85.3 | 85.3 | 85.3 | 85.3 | 85.3 |
| f | 7.328 | 7.328 | 7.354 | 7.358 | 7.357 |
| f1 | 7.266 | 7.203 | 7.180 | 7.064 | 7.129 |
| f2 | −16.462 | −17.544 | −18.312 | −17.214 | −17.285 |
| f3 | 40.284 | 44.359 | 53.318 | 60.143 | 54.694 |
| f4 | −60.427 | −43.129 | −39.995 | −33.451 | −33.639 |
| f5 | 37.216 | 42.589 | 38.857 | 38.014 | 39.881 |
| f6 | −15.053 | −26.743 | −45.616 | −46.602 | −47.242 |
| f7 | 6.117 | 6.770 | 7.844 | 7.280 | 7.273 |
| f8 | −5.814 | −5.416 | −5.688 | −5.703 | −5.723 |
| R1 | 2.986 | 3.020 | 3.004 | 3.104 | 3.108 |
| R2 | 10.363 | 11.187 | 10.970 | 13.624 | 13.220 |
| T1 | 1.183 | 1.181 | 1.227 | 1.240 | 1.237 |
| d45 | 0.210 | 0.090 | 0.087 | 0.096 | 0.095 |
| v1 | 55.990 | 55.990 | 55.990 | 55.990 | 55.990 |
| v2 | 19.238 | 19.238 | 19.238 | 19.238 | 19.238 |
| v4 | 18.408 | 18.408 | 18.408 | 18.408 | 18.408 |

In Table 21, Fno is an F-number of the optical imaging system, IMG HT is one half of a diagonal length of an imaging plane, and FOV is a field of view of the optical imaging system.

f is a total focal length of the optical imaging system, f1 is a focal length of a first lens, f2 is a focal length of a second lens, f3 is a focal length of a third lens, f4 is a focal length of a fourth lens, f5 is a focal length of a fifth lens, f6 is a focal length of a sixth lens, f7 is a focal length of a seventh lens, and f8 is a focal length of an eighth lens.

Table 22 below lists values of Conditional Expressions 1 to 17 according to the first to tenth embodiments of the present disclosure.

TABLE 22

| Conditional Expression | Emb. 1 | Emb. 2 | Emb. 3 | Emb. 4 | Emb. 5 |
|---|---|---|---|---|---|
| TTL/(2 × IMG HT) | 0.6193 | 0.6193 | 0.6193 | 0.6201 | 0.6201 |
| Fno | 1.574 | 1.574 | 1.573 | 1.573 | 1.573 |
| (TTL/(2 × IMG HT)) × Fno | 0.9748 | 0.9748 | 0.9741 | 0.9754 | 0.9754 |
| d45/TTL | 0.01050 | 0.00577 | 0.01165 | 0.02419 | 0.02419 |
| TTL/f | 1.1670 | 1.1672 | 1.1672 | 1.1846 | 1.1846 |
| TTL/BFL | 8.4503 | 8.0952 | 8.0204 | 7.0808 | 7.0635 |
| v2 + v4 | 36.8160 | 36.8160 | 38.4760 | 37.6460 | 37.6460 |
| v1 − (v2 + v4) | 19.1740 | 19.1740 | 17.5140 | 18.3440 | 18.3440 |
| R1/R2 | 0.2051 | 0.1875 | 0.1993 | 0.3131 | 0.3187 |
| (R1/R2)/T1 | 0.1650 | 0.1513 | 0.1669 | 0.2620 | 0.2678 |
| f1/f | 0.9106 | 0.8961 | 0.9196 | 1.0057 | 1.0134 |
| f2/f | −2.1955 | −2.0040 | −2.0372 | −2.5240 | −2.5446 |
| f3/f | 9.0734 | 6.5501 | 7.2742 | 5.8328 | 6.0590 |
| f4/f | −5.0073 | −8.4635 | −7.3477 | −9.0075 | −8.8251 |
| \|f1/f2\| | 0.4148 | 0.4471 | 0.4514 | 0.3985 | 0.3982 |
| \|f1/f3\| | 0.1004 | 0.1368 | 0.1264 | 0.1724 | 0.1673 |
| \|f2/f3\| | 0.2420 | 0.3060 | 0.2801 | 0.4327 | 0.4200 |
| Conditional Expression | Emb. 6 | Emb. 7 | Emb. 8 | Emb. 9 | Emb. 10 |
| TTL/(2 × IMG HT) | 0.6200 | 0.6201 | 0.6199 | 0.6343 | 0.6344 |
| Fno | 1.573 | 1.573 | 1.574 | 1.574 | 1.574 |
| (TTL/(2 × IMG HT)) × Fno | 0.9753 | 0.9754 | 0.9758 | 0.9984 | 0.9986 |
| d45/TTL | 0.02419 | 0.01037 | 0.01002 | 0.01081 | 0.01070 |
| TTL/f | 1.1845 | 1.1846 | 1.1802 | 1.2068 | 1.2073 |
| TTL/BFL | 7.0915 | 7.3257 | 7.3056 | 7.0870 | 7.0548 |
| v2 + v4 | 37.6460 | 37.6460 | 37.6460 | 37.6460 | 37.6460 |
| v1 − (v2 + v4) | 18.3440 | 18.3440 | 18.3440 | 18.3440 | 18.3440 |
| R1/R2 | 0.2881 | 0.2700 | 0.2738 | 0.2278 | 0.2351 |
| (R1/R2)/T1 | 0.2436 | 0.2286 | 0.2232 | 0.1837 | 0.1901 |
| f1/f | 0.9915 | 0.9829 | 0.9763 | 0.9600 | 0.9690 |
| f2/f | −2.2465 | −2.3941 | −2.4901 | −2.3395 | −2.3495 |
| f3/f | 5.4973 | 6.0534 | 7.2502 | 8.1738 | 7.4343 |
| f4/f | −8.2460 | −5.8855 | −5.4385 | −4.5462 | −4.5724 |
| \|f1/f2\| | 0.4414 | 0.4106 | 0.3921 | 0.4104 | 0.4124 |
| \|f1/f3\| | 0.1804 | 0.1624 | 0.1347 | 0.1175 | 0.1303 |
| \|f2/f3\| | 0.4086 | 0.3955 | 0.3434 | 0.2862 | 0.3160 |

According to embodiments of the present disclosure, an optical imaging system may have a reduced size and a high resolution.

While this disclosure includes specific embodiments, it will be apparent after an understanding of the disclosure of this application that various changes in form and detail may be made in these embodiments without departing from the spirit and scope of the claims and their equivalents. Descriptions of features or aspects in each embodiment are to be considered as being applicable to similar features or aspects in other embodiments. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens, a second lens, a third lens, a fourth lens, a fifth lens, a sixth lens, a seventh lens, and an eighth lens sequentially disposed in ascending numerical order along an optical axis of the optical imaging system from an object side of the optical imaging system toward an imaging plane of the optical imaging system,
wherein the first lens has a positive refractive power, the second lens has a negative refractive power, and the third lens has a positive refractive power, and
the following conditional expressions are satisfied:
$$0.95 < ( TTL / ( 2 \times IMG HT ) ) \times Fno < 1.$$
$$6.9 < TTL / BFL < 8.5$$
where TTL is a distance along the optical axis from an object-side surface of the first lens to the imaging plane, IMG HT is one half of a diagonal length of the imaging plane, Fno is an F-number of the optical imaging system, and BFL is a distance along the optical axis from an image-side surface of the eighth lens to the imaging plane.

2. The optical imaging system of claim 1, wherein a refractive index of the second lens is greater than a refractive index of the first lens and a refractive index of the third lens, and
a refractive index of the fourth lens is greater than the refractive index of the third lens and a refractive index of the fifth lens.

3. The optical imaging system of claim 1, wherein the second lens and the fourth lens each have a refractive index greater than 1.67.

4. The optical imaging system of claim 1, wherein the fourth lens has a negative refractive power, and
the second lens and the fourth lens each have an Abbe number less than 20.

5. The optical imaging system of claim 1, wherein either one or both of the following conditional expressions is satisfied:
$$30 < v 2 + v 4 < 40$$
$$15 < v 1 - ( v 2 + v 4 ) < 20$$
where v1 is an Abbe number of the first lens, v2 is an Abbe number of the second lens, and v4 is an Abbe number of the fourth lens.

6. The optical imaging system of claim 1, wherein 1.5<Fno<1.58 is satisfied.

7. The optical imaging system of claim 1, wherein 0.6<TTL/(2×IMG HT)<0.64 is satisfied.

8. The optical imaging system of claim 1, wherein 0<d45/TTL<0.03 is satisfied, where d45 is a distance along the optical axis between an image-side surface of the fourth lens and an object-side surface of the fifth lens.

9. The optical imaging system of claim 1, wherein 1.1<TTL/f<1.25 is satisfied, where f is a total focal length of the optical imaging system.

10. The optical imaging system of claim 1, wherein 0.15<R1/R2<0.35 is satisfied, where R1 is a radius of curvature of the object-side surface of the first lens at the optical axis, and R2 is a radius of curvature of an image-side surface of the first lens at the optical axis.

11. The optical imaging system of claim 1, wherein 0.12<(R1/R2)/T1<0.3 is satisfied, where R1 is a radius of curvature of the object-side surface of the first lens at the optical axis, R2 is a radius of curvature of an image-side surface of the first lens at the optical axis, and T1 is a thickness of the first lens along the optical axis.

12. The optical imaging system of claim 1, wherein 0.85<f1/f<1.05 is satisfied, where f1 is a focal length of the first lens, and f is a total focal length of the optical imaging system.

13. The optical imaging system of claim 1, wherein −3<f2/f<−1.8 is satisfied, where f2 is a focal length of the second lens, and f is a total focal length of the optical imaging system.

14. The optical imaging system of claim 1, wherein 0.3<|f1/f2|<0.5 is satisfied, where f1 is a focal length of the first lens, and f2 is a focal length of the second lens.

15. The optical imaging system of claim 1, wherein the seventh lens has a positive refractive power, and the eighth lens has a negative refractive power.

16. The optical imaging system of claim 1, wherein the object-side surface of the first lens is convex in a paraxial region thereof, and an image-side surface of the first lens is concave in a paraxial region thereof,
an object-side surface of the second lens is convex in a paraxial region thereof, and an image-side surface of the second lens is concave in a paraxial region thereof, and
an object-side surface of the third lens is convex in a paraxial region thereof, and an image-side surface of the third lens is concave in a paraxial region thereof.

17. The optical imaging system of claim 1, wherein 5<f3/f<10 is satisfied, where f3 is a focal length of the third lens, and f is a total focal length of the optical imaging system.

18. The optical imaging system of claim 1, wherein −10<f4/f<−4 is satisfied, where f4 is a focal length of the fourth lens, and f is a total focal length of the optical imaging system.

19. The optical imaging system of claim 1, wherein 0.07<|f1/f3|<0.2 is satisfied, where f1 is a focal length of the first lens, and f3 is a focal length of the third lens.

20. The optical imaging system of claim 1, wherein 0.2<|f2/f3|<0.5 is satisfied, where f2 is a focal length of the second lens, and f3 is a focal length of the third lens.
